(19) United States
(12) Patent Application Publication
(10) Pub. No.: US 2026/0213804 A1
(43) Pub. Date: Jul. 23, 2026

(54) Enhanced Type-II CSI Reporting

(71) Applicant: Fraunhofer-Gesellschaft zur Förderung der angewandten Forschung e.V., MÜNCHEN (DE)

(72) Inventors: Marcus Grossmann, Erlangen (DE); Markus Landmann, Erlangen (DE); Venkatesh Ramireddy, Erlangen (DE)

(73) Assignee: Fraunhofer-Gesellschaft zur Förderung der angewandten Forschung e.V., MÜNCHEN (DE)

(21) Appl. No.: 19/135,918

(22) PCT Filed: Dec. 6, 2023
(86) PCT No.: PCT/EP2023/084582

§ 371 Date: Jun. 5, 2025

(30) Foreign Application Priority Data
Dec. 6, 2022 (EP) 22211759.0

(51) Int. Cl. H04B 7/06; H04W 72/044

(52) U.S. Cl. CPC H04B 7/0626; H04W 72/044

(57) ABSTRACT

The embodiment of the present disclosure relates to a method performed by a wireless device (500) for generating and reporting a CSI, report The embodiments also relate to a method performed by a network device (600) for receiving a CSI report. The method by the wireless device (500) includes: receiving (400) a CSI report configuration from a network node (600); determining (401) a number of precoder coefficients for RI transmission layers of a precoder vector or matrix; determining (402) a bitmap for indicating the non-zero combining coefficients and assigning an ordering to the bits of the bitmap; assigning the same ordering to the plurality of combining coefficients, dividing (403) the plurality of combining coefficients into two or more CSI groups having associated priority levels; and generating (404) a CSI report comprising an indication of the SD, FD, TD components and the bitmap, wherein the CSI report comprises CSI part 1 and CSI part 2, wherein CSI part 1 has a fixed payload size and comprises information indicating the size of the payload of CSI part 2, and wherein CSI part 2 includes the combining coefficients of at least one of the two or more CSI groups; and transmitting (405) or reporting an uplink control information (UCI) including the CSI report over an uplink (UL) channel to the network node (600).

### TECHNICAL FIELD

The present disclosure relates to the field of wireless communications, and in particular to methods and apparatuses for Channel State Information (CSI) feedback reporting and Uplink Control Channel (UCI) or CSI omission for a codebook based precoding in a wireless communications network such as advanced 5G networks.

### BACKGROUND

The fifth generation (5G) mobile communications system also known as new radio (NR) provides a higher level of performance than the previous generations of mobile communications system. 5G mobile communications has been driven by the need to provide ubiquitous connectivity for applications as diverse automotive communication, remote control with feedback, video downloads, as well as data applications for Internet-of-Things (IoT) devices, machine type communication (MTC) devices, etc. 5G wireless technology brings several main benefits, such as faster speed, shorter delays and increased connectivity. The third-generation partnership project (3GPP) provides the complete system specification for the 5G network architecture, which includes at least a radio access network (RAN), core transport networks (CN) and service capabilities.

FIG. 1 illustrates a simplified schematic view of an example of a wireless communications network 100 including a core network (CN) 110 and a radio access network (RAN) 120. The RAN 120 is shown including a plurality of network nodes or radio base stations, which in 5G are called gNBs. Three radio base stations are depicted gNB1, gNB2 and gNB3. Each gNB serves an area called a coverage area or a cell. FIG. 1 illustrates 3 cells 121, 122 and 123, each served by its own gNB, gNB1, gNB2 and gNB3, respectively. It should be mentioned that the network 100 may include any number of cells and gNBs. The radio base stations, or network nodes serve users within a cell. In 4G or LTE, a radio base station is called an eNB, in 3G or UMTS, a radio base station is called an eNodeB, and BS in other radio access technologies. A user or a user equipment (UE) may be a wireless or a mobile terminal device or a stationary communication device. A mobile terminal device or a UE may also be an IoT device, an MTC device, etc. IoT devices may include wireless sensors, software, actuators, and computer devices. They can be imbedded into mobile devices, motor vehicle, industrial equipment, environmental sensors, medical devices, aerial vehicles and more, as well as network connectivity that enables these devices to collect and exchange data across an existing network infrastructure.

Referring back to FIG. 1, each cell is shown including UEs and IoT devices. gNB1 in cell 121 serves UE1 121A, UE2 121B and IoT device 121C. Similarly, gNB2 in cell 121 serves UE3 122A, UE4 122B and IoT device 122C, and gNB3 in cell 123 serves UE5 123A, UE6 123B and IoT device 123C. The network 100 may include any number of UEs and IoT devices or any other types of devices. The devices communicate with the serving gNB(s) in the uplink and the gNB(s) communicate with the devices in the downlink. The respective base station gNB1 to gNB3 may be connected to the CN 120, e.g., via the S1 interface, via respective backhaul links 111, 121D, 122D, 123D, which are schematically depicted in FIG. 1 by the arrows pointing to “core”. The core network 120 may be connected to one or more external networks, such as the Internet. The gNBs may be connected to each other via the S1 interface or the X2 interface or the XN interface in 5G, via respective interface links 121E, 122E and 123E, which is depicted in the figure by the arrows pointing to gNBs.

For data transmission, a physical resource grid may be used. The physical resource grid may comprise a set of resource elements (REs) to which various physical channels and physical signals are mapped. For example, the physical channels may include the physical downlink, uplink and/or sidelink (SL) shared channels (PDSCH, PUSCH, PSSCH) carrying user specific data, also referred to as downlink, uplink or sidelink payload data, the physical broadcast channel (PBCH) carrying for example a master information block (MIB) and a system information block (SIB), the physical downlink, uplink and/or sidelink control channels (PDCCH, PUCCH, PSCCH) carrying for example the downlink control information (DCI), the uplink control information (UCI) or the sidelink control information (SCI). For the uplink, the physical channels may further include the physical random-access channel (PRACH or RACH) used by UEs for accessing the network once a UE is synchronized and obtains the MIB and SIB. The physical signals may comprise reference signals (RS), synchronization signals (SSs) and the like. The resource grid may comprise a frame or radio frame having a certain duration, like 10 milliseconds, in the time domain and having a given bandwidth in the frequency domain. The radio frame may have a certain number of subframes of a predefined length, e.g., 2 subframes with a length of 1 millisecond. Each subframe may include two slots of a number of OFDM symbols depending on the cyclic prefix (CP) length. IN 5G, each slot consists of 14 OFDM symbols or 12 OFDM symbols based on normal CP and extended CP respectively. A frame may also consist of a smaller number of OFDM symbols, e.g., when utilizing shortened transmission time intervals (TTIs) or a mini-slot/non-slot-based frame structure comprising just a few OFDM symbols. Slot aggregation is supported in 5G NR and hence data transmission can be scheduled to span one or multiple slots. Slot format indication informs a UE whether an OFDM symbol is downlink, uplink or flexible.

The wireless communication network system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the 5G or NR (New Radio) standard.

The wireless communications network system depicted in FIG. 1 may be a heterogeneous network having two distinct overlaid networks, a network of macro cells with each macro cell including a macro base station, like base station gNB1 to gNB3, and a network of small cell base stations (not shown in FIG. 1), like femto- or pico-base stations. In addition to the above described wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-advanced pro standard or the 5G or NR, standard.

In the wireless communications network system such as the one depicted schematically in FIG. 1, multi-antenna techniques may be used, e.g., in accordance with LTE, NR or any other communication system, to improve user data rates, link reliability, cell coverage and network capacity. To support multi-stream or multi-layer transmissions, linear precoding is used in the physical layer of the communication system. Linear precoding is performed by a precoder matrix which maps layers of data to antenna ports. The precoding may be seen as a generalization of beamforming, which is a technique to spatially direct or focus a data transmission towards an intended receiver. The precoder matrix to be used at the gNB to map the data to the transmit antenna ports is decided using channel state information, CSI.

In the wireless communications network system as described above, such as LTE or New Radio (5G), downlink signals convey data signals, control signals containing downlink, DL, control information (DCI), and a number of reference signals or symbols (RS) used for different purposes. A gNodeB (or gNB or base station) transmits data and downlink control information (DCI) through the so-called physical downlink shared channel (PDSCH) and physical downlink control channel (PDCCH) or enhanced PDCCH (ePDCCH), respectively. Moreover, the downlink signal(s) of the gNB may contain one or multiple types of reference signals (RSs) including a common RS (CRS) in LTE, a channel state information RS (CSI-RS), a demodulation RS (DM-RS), and a phase tracking RS (PT-RS). The CRS is transmitted over a DL system bandwidth part and used at the user equipment (UE) to obtain a channel estimate to demodulate the data or control information. The CSI-RS is transmitted with a reduced density in the time and frequency domain compared to CRS and used at the UE for channel estimation or for channel state information (CSI) acquisition. The DM-RS is transmitted only in a bandwidth part of the respective PDSCH and used by the UE for data demodulation. For signal precoding at the gNB, several CSI-RS reporting mechanisms are used such as non-precoded CSI-RS and beamformed CSI-RS reporting. For a non-precoded CSI-RS, a one-to-one mapping between a CSI-RS port and a transceiver unit, TXRU, of the antenna array at the gNB is utilized. Therefore, non-precoded CSI-RS provides a cell-wide coverage where the different CSI-RS ports have the same beam direction and beam width. For beamformed/precoded UE-specific or non-UE-specific CSI-RS, a beamforming operation is applied over a single antenna port or over multiple antenna ports to have several narrow beams with high gain in different directions and, therefore, no cell-wide coverage.

In a wireless communications network system employing time division duplexing, TDD, due to channel reciprocity, the CSI is available at the base station (gNB). However, when employing frequency division duplexing, FDD, due to the absence of channel reciprocity, the channel is estimated at the UE and the estimate is fed back to the gNB. FIG. 2 shows a block-based model of a Multiple Input Multiple Output (MIMO) DL transmission using codebook-based-precoding in accordance with LTE release 8. FIG. 2 shows schematically the base station 200, gNB, the user equipment, UE, 202 and the channel 204, like a radio channel for a wireless data communication between the base station 200 and the user equipment 202. The base station includes an antenna array ANT_{T} having a plurality of antennas or antenna elements, and a precoder 206 receiving a data vector 208 and a precoder matrix F from a codebook 210. The channel 204 may be described by the channel tensor/matrix 212. The user equipment 202 receives the data vector 214 via an antenna or an antenna array ANT_{R} having a plurality of antennas or antenna elements. A feedback channel 216 between the user equipment 202 and the base station 200 is provided for transmitting feedback information. The previous releases of 3GPP up to Release 15 support the use of several downlink reference symbols (such as CSI-RS) for CSI estimation at the UE.

In FDD systems (up to Rel. 15), the estimated channel at the UE is reported to the gNB implicitly where the CSI report transmitted by the UE over the feedback channel includes the rank index (RI), the precoding matrix index (PMI) and the channel quality index (CQI) (and the CRI from Rel. 13) allowing, at the gNB, to decide the precoding matrix, and the modulation order and coding scheme (MCS) of the symbols to be transmitted. The PMI and the RI are used to determine the precoding matrix from a predefined set of matrices Ω also referred to as codebook. The codebook, e.g., in accordance with LTE, may be a look-up table with matrices in each entry of the table, and the PMI and RI from the UE decide from which row and column of the table the precoder matrix to be used is obtained. The precoders and codebooks are designed up to Rel. 15 for gNBs equipped with one-dimensional Uniform Linear Arrays (ULAs) having N₁ dual-polarized antennas (in total Nₜ=2N₁ antennas), or with two-dimensional Uniform Planar Arrays (UPAs) having dual-polarized antennas at N₁N₂ positions (in total Nₜ=2N₁N₂ antennas). The ULA allows controlling the radio wave in the horizontal (azimuth) direction only, so that azimuth-only beamforming at the gNB is possible, whereas the UPA supports transmit beamforming on both vertical (elevation) and horizontal (azimuth) directions, which is also referred to as full-dimension (FD) MIMO. The codebook, e.g., in the case of massive antenna arrays such as FD-MIMO, may be a set of beamforming weights that forms spatially separated electromagnetic transmit/receive beams using the array response vectors of the array. The beamforming weights (also referred to as the array steering vectors) of the array are amplitude gains and phase adjustments that are applied to the signal fed to the antennas (or the signal received from the antennas) to transmit (or obtain) a radiation towards (or from) a particular direction. The components of the precoder matrix are obtained from the codebook, and the PMI and the RI are used to read the codebook and obtain the precoder. The array steering vectors may be described by the columns of a 2 Dimensional Discrete Fourier Transform (DFT) matrix when ULAs or UPAs are used for signal transmission.

The precoder matrices used in the Type-I, Type-I multi-panel and Type-II CSI reporting schemes in 3GPP New Radio Rel. 15 are defined in the frequency-domain and have a dual-stage structure (i.e., two components codebook): F(s)=F₁F₂(s), s=0 . . . , S−1, where S denotes the number of subbands. The first component or the so-called first stage precoder, F₁, is used to select a number of beam vectors from a Discrete Fourier Transform-based (DFT-based) matrix, which is also called the spatial codebook. Moreover, the first stage precoder, F₁, corresponds to a wide-band matrix, independent of the subband index s, and contains L spatial beamforming vectors (the so-called spatial beams) bₗ∈ [symbol] ^{N}^{₁}^{N}^{₂}^{×1}, l=0, . . . , L−1 selected from a DFT-based codebook matrix for the two polarizations of the antenna array,

$${F}_{1} = [ \begin{matrix}{b}_{0} , … , {b}_{L - 1} & \begin{matrix}0 & … & 0\end{matrix} \\ \begin{matrix}0 & … & 0\end{matrix} & {b}_{0} , … , {b}_{L - 1}\end{matrix} ] ∈ {ℂ}^{2 {N}_{1} {N}_{2} \times 2 L} .$$

For the type-I codebook, L=1 such that F₁ is simply given by

$${F}_{1} = [ \begin{matrix}{b}_{0} & 0 \\ 0 & {b}_{0}\end{matrix} ] ∈ {ℂ}^{2 {N}_{1} {N}_{2} \times 2} .$$

The spatial codebook comprises an oversampled DFT matrix of dimension N₁N₂×N₁O₁N₂O₂, where O₁ and O₂ denote the oversampling factors with respect to the first and second dimension of the codebook, respectively. The DFT vectors in the codebook are grouped into (q₁,q₂), 0≤q₁≤O₁−1, 0≤q₂≤O₂−1 subgroups, where each subgroup contains N₁N₂ DFT-based vectors, and the parameters q₁ and q₂ are denoted as the rotation oversampling factors, with respect to the first and second dimension of the antenna array, respectively.

The second component or the so-called second stage precoder, F₂(s), is used to combine the selected beam vectors. This means the second stage precoder, F₂(s), corresponds to a selection/combining/co-phasing matrix to select/combine/co-phase the beams defined in F₁ for the s-th configured sub-band. For example, for a rank-1 transmission and Type-I CSI reporting, F₂(s) is given for a dual-polarized antenna array by

$${F}_{2} ( s ) = [ \begin{matrix}1 \\ {e}^{{j δ}_{1}}\end{matrix} ] ,$$

e^{jδ}^{₁} is a quantized co-phasing factor (phase adjustment) between the two orthogonal polarizations of the antenna array. Hence, for the Type-I codebook, a single DFT-beam is selected per transmission layer of the precoding such that the transmission is directed for the strongest path component of the radio channel.

For a rank-1 transmission and Type-II CSI reporting, F₂ (s) is given for dual-polarized antenna arrays by

$${F}_{2} ( s ) = [ \begin{matrix}{e}^{{j δ}_{0}} {p}_{0} \\ ⋮ \\ {e}^{{j δ}_{2 L - 1}} {p}_{2 L - 1}\end{matrix} ] ∈ {ℂ}^{2 L \times 1}$$

where pₗ and e^{jδ}^{ₗ}, l=0, 2, . . . , 2L−1 are quantized amplitude and phase beam-combining coefficients, respectively. For rank-R transmission, F₂(s) contains R vectors, wherein R denotes the transmission rank, where the entries of each vector are chosen to combine single or multiple beams within each polarization.

The selection of the matrices F₁ and F₂(s) is performed by the UE based on reference signals such as CSI-RS and the knowledge of the channel conditions. The selected matrices are indicated in a CSI report in the form of a RI (the RI denotes the rank of the precoding matrices) and a PMI and are used at the gNB to update the multi-user precoder for the next transmission time interval.

In addition to the Type-I codebook, the Rel. 15 3GPP specification also defines a Type-I multi-panel (multi-antenna array) codebook for the case the gNB is equipped with multiple (co-located) antenna panels or antenna arrays that are possibly un-calibrated. The precoder for this codebook is similar to the Type-I codebook where a single DFT beam is applied per transmission layer of the precoding matrix. To take into account different spacing between the antenna panels and/or possible phase calibrations errors (e.g., due to different local oscillators) between the antenna panels, a per-panel co-phasing factor is applied to each panel. For example, for a rank-1 transmission and a gNB that is equipped with N_{g}=2 antenna panels, the Type-I multi-panel CSI reporting is defined as

$$F ( s ) = [ \begin{matrix}{b}_{0} \\ {e}^{j {δ}_{1}} {b}_{0} \\ {e}^{j {δ}_{2}} {b}_{0} \\ {e}^{j {δ}_{1}} {e}^{j {δ}_{2}} {b}_{0}\end{matrix} ] ,$$

where e^{jδ}^{₁} and e^{jδ}^{₂} are quantized co-phasing factors with e^{jδ}^{₂} being a panel-specific co-phasing factor applied to the second panel.

For the 3GPP Rel.-15 dual-stage Type-II CSI reporting, the second stage precoder, F₂(s), is calculated on a subband basis such that the number of columns of

$${F}_{2} = [ {F}_{2}^{( r )} ( 0 ) ... {F}_{2}^{( r )} ( s ) ... {F}_{2}^{( r )} ( S - 1 ) ]$$

for the r-th transmission layer depends on the number of configured CQI subbands S. Here, a subband refers to a group of adjacent physical resource blocks (PRBs). A drawback of the Type-II CSI feedback is the large feedback overhead for reporting the combining coefficients on a subband basis. The feedback overhead increases approximately linearly with the number of subbands and becomes considerably large for large numbers of subbands. To overcome the high feedback overhead of the Rel.-15 Type-II CSI reporting scheme, it has been decided in 3GPP RAN #81 to study feedback compression schemes for the second stage precoder F₂. In several contributions, it has been demonstrated that the number of beam-combining coefficients in F₂ may be drastically reduced when transforming F₂ using a small set of DFT-based basis vectors into the transform domain referred to as the delay domain. The corresponding three-stage precoder relies on a three-stage (i.e., three components)

$${F}_{1} {F}_{2}^{( r )} {F}_{3}^{( r )}$$

codebook. The first component, represented by the matrix F₁, is identical to the Rel.-15 NR component, is independent of the transmission layer (r), and contains a number of spatial domain (SD) basis vectors selected from the spatial codebook. The second component, represented by the matrix

$${F}_{3}^{( r )} ,$$

is layer-dependent and is used to select a number of delay domain (DD) basis vectors from a Discrete Fourier Transform-based (DFT-based) matrix which is also called the delay codebook. The third component, represented by the matrix

$${F}_{2}^{( r )} ,$$

contains a number of combining coefficients that are used to combine the selected SD basis vectors and DD basis vectors from the spatial and delay codebooks, respectively.

Assuming a rank-R transmission the three-component precoder matrix or CSI matrix for a configured 2N₁N₂ antenna/CSI-RS ports and configured S subbands is represented for a first polarization of the antenna ports and r-th transmission layer as

$${F}^{( r , 1 )} = {α}^{( r )} {{\sum }_{l = 0}}^{L - 1} {b}_{l} {{\sum }_{d = 0}}^{D - 1} {γ}_{1 , l , d}^{( r )} {d}_{d}^{( r )}$$

and for a second polarization of the antenna ports and r-th transmission layer as

$${F}^{( r , 2 )} = {α}^{( r )} {{\sum }_{l = 0}}^{L - 1} {b}_{l} {{\sum }_{d = 0}}^{D - 1} {γ}_{2 , l , d}^{( r )} {d}_{d}^{( r )} ,$$

where bᵤ (l=0, . . . , L−1) represents the u-th SD basis vector selected from the spatial codebook,

$${d}_{d}^{( r )} ( d = 0 , ... , D - 1 )$$

is the d-th DD basis vector associated with the r-th layer selected from the delay codebook,

$${γ}_{p , l , d}^{( r )}$$

is the complex delay-domain combining coefficient associated with the u-th SD basis vector, the d-th DD basis vector and the p-th polarization, D represents the number of configured DD basis vectors, and α^{(r)} is a normalizing scalar.

An advantage of the three-component CSI reporting scheme in the above equations is that the feedback overhead for reporting the combining coefficient of the precoder matrix or CSI matrix is no longer dependent on the number of configured CQI subbands (i.e., it is independent from the system bandwidth). Therefore, the above three-component codebook has been adopted for the 3GPP Rel.-16 dual-stage Type-II CSI reporting specification.

An inherent drawback of the current CSI Type-II based CSI reporting schemes is that the RI and PMI only contain information of the current channel conditions. Consequently, the CSI reporting rate is related to the channel coherence time which defines the time duration over which the channel is considered to be not varying. This means, in quasi-static channel scenarios, where the wireless device does not move or moves slowly, the channel coherence time is large, and the CSI needs to be less frequently updated. However, if the channel conditions change fast, for example due to a high or fast movement of the wireless device (or UE) in a multi-path channel environment, the channel coherence time is short and the transmit signals experience severe fading caused by a e.g. Doppler-frequency spread. For such channel conditions, the CSI needs to be updated frequently which causes a high feedback overhead. Especially, for NR systems (Rel. 16) that are likely to be more multi-user centric, the multiple CSI reports from users (or UEs) in highly-dynamic channel scenarios will drastically reduce the overall efficiency of the communication system.

UCI omission for CSI reporting UCI or CSI omission for PUSCH-based resource allocation and CSI reporting was introduced in 3GPP Rel-15. It allows a wireless device or UE to drop some parts of one or more CSI report(s) in the case that the PUSCH resource allocation is not sufficient to carry the entire content of the CSI report(s). UCI omission may happen when the base station did not accurately allocate the PUSCH resources when scheduling the CSI report(s). For example, the base station may allocate resources for a rank-1 (RI=1) CSI report, but the UE determines a rank-2 transmission and reports a rank-2 (RI=2) CSI report of which size is larger than the size of the allocated PUSCH resources. In such a case, the UE has to drop a portion of the UCI content. In 3GPP Rel. 15 and Rel. 16 the dropping is achieved by decomposing the UCI payload associated with the CSI reports into smaller portions, the so-called priority levels, where priority level 0 has the highest priority, and represents the total number of CSI reports configured to be carried on the PUSCH. Each priority level is associated with a part of a CSI report. The UE drops the CSI portions with lower priority such that the payload size of the CSI reports fits with the PUSCH resource allocation. The CSI report is decomposed into a number of CSI portions. Here, a CSI portion, or the so-called subband PMI in Rel. 15, contains the CSI content(s) associated with the even or odd subbands of the CSI report. Moreover, each subband PMI is associated with a priority level. The motivation behind the Rel. 15 subband-based CSI decomposition and omission method is that in case of omission of a first subband PMI of CSI report n, the base station may use the CSI content of the reported second subband PMI of CSI report n to estimate the CSI of the omitted first subband PMI by using an interpolation scheme. In this way, a severe degradation of the performance can be avoided as neighbored subbands are typically highly correlated.

There are thus drawbacks with the known solutions as described above and the present invention according to the present disclosure addresses these drawbacks. Consequently, new enhanced CSI reporting, schemes and rules, for example CSI or UCI omission, are required.

### SUMMARY

It is an objective of the embodiments herein to provide methods and apparatuses for CSI feedback reporting for a codebook based precoding in a wireless communications network such as advanced 5G networks.

According to an aspect of some embodiments herein, there is provided a method performed by a wireless device (or user equipment) for generating and reporting or transmitting a channel state information, CSI, report in a wireless communication system, the CSI report indicating a plurality of precoder vectors or matrices, a precoder vector or matrix being expressed as a linear combination of spatial-domain component(s), frequency-domain component(s) and time-domain component(s), and a set of linear combination coefficients for combining the spatial-, frequency- and time-domain components, the method comprising:
receiving a CSI report configuration from a network node;
determining based on the received CSI report configuration information a number of precoder coefficients for RI transmission layers of a precoder vector or matrix;
determining a bitmap for indicating the non-zero combining coefficients from the set of linear combining coefficients, and assigning an ordering to the bits of the bitmap and assigning the same ordering to the plurality of combining coefficients,
dividing the plurality of combining coefficients into two or more CSI groups having associated priority levels;
generating a CSI report comprising an indication of the SD, FD, TD components and the bitmap, wherein the CSI report comprises CSI part 1 and CSI part 2, wherein CSI part 1 has a fixed payload size and comprises information indicating the size of the payload of CSI part 2, and wherein CSI part 2 includes the combining coefficients of at least one of the two or more CSI groups; and transmitting or reporting an uplink control information (UCI) including the CSI report over an uplink (UL) channel to the network node.

According to an aspect of some embodiments herein, the method comprises to determine one or more spatial domain, SD, components, one or more frequency domain, FD, components, one or more time domain, TD, components for the set of linear combination coefficients for the precoding vector or matrix, and to indicate the SD, FD, and TD component(s) in the CSI report.

According to an aspect of some embodiments herein, the method comprises to determine a number, S, FD-TD, or SD-TD, or SD-FD component pairs and to indicate the S FD-TD, or SD-TD, or SD-FD component pairs in the CSI report.

According to an aspect of some embodiments herein, the method comprises to indicate the value of S in CSI part 1 or CSI part 2 of the CSI report.

According to an aspect of some embodiments herein, the method comprising multiple CSI groups in a CSI report used for UCI or CSI omission, and a bitmap comprising RI bit fields, wherein the r-th bit field is associated with an r-th layer index and comprises 2LS bits and the ordering of the bits within each bit field is a function of the SD component index (l) and FD-TD component pair index (s), given by u=2Ls+l, or u=Sl+s, wherein l={0, . . . , 2L−1}, and s={0, . . . , S−1}.

According to an aspect of some embodiments herein, the method comprising multiple CSI groups in a CSI report for UCI or CSI omission, and the bitmap comprises S bit fields, wherein the s-th bit field is associated with an s-th FD-TD component pair index and comprises 2L·RI bits and the ordering of the bits within each bit field is a function of the SD component index (l) and layer index (r), given by u=2Lr+l, or u=RI·l+r, wherein l={0, . . . , 2L−1}, and r={0, . . . , RI−1}.

According to an aspect of some embodiments herein, the method comprising a mapping between the associated FD component and TD component to the s-th FD-TD component pair per layer by s=Qm+q or s=Mq+m, where q∈{0, . . . , Q−1} is a TD component index and m∈{0, . . . , M−1} is a FD component index.

According to an aspect of some embodiments herein, there is provided a method performed by a network node for receiving a channel state information, CSI, report in a wireless communication system, the CSI report indicating a plurality of precoder vectors or matrices, a precoder vector or matrix being expressed as a linear combination of spatial-domain component(s), frequency-domain component(s) and time-domain component(s), and a set of linear combination coefficients for combining the spatial-, frequency- and time-domain components, the method comprising:
transmitting to a wireless device, a CSI report configuration; for enabling the wireless device to determine a number of precoder coefficients for RI transmission layers of a precoder vector or matrix; determine a bitmap for indicating the non-zero combining coefficients from the set of linear combining coefficients, and assigning an ordering to the bits of the bitmap and assigning the same ordering to the plurality of combining coefficients, dividing the plurality of combining coefficients into two or more CSI groups having associated priority levels; generate and transmit or report an uplink control information (UCI) including the CSI report over an uplink (UL) channel to the network node; and
receiving, from the wireless device, a CSI report, the CSI report comprising an indication of the SD, FD, TD components and the bitmap, wherein the CSI report comprises CSI part 1 and CSI part 2, wherein CSI part 1 has a fixed payload size and comprises information indicating the size of the payload of CSI part 2, and wherein CSI part 2 includes the combining coefficients of at least one of the two or more CSI groups.

According to an aspect of some embodiments herein, there is provided a network node comprising a processor and a memory containing instructions executable by said processor, whereby the network node is operative to perform the method of claim 8.

According to an aspect of some embodiments herein, there is provided a wireless device comprising a processor and a memory containing instructions executable by said processor, whereby the wireless device is operative to perform any of claims 1-7.

There is also provided a computer program comprising instructions which when executed on at least one processor of the wireless device, cause the at least said one processor to carry out the actions or method steps presented herein.

There is also provided a computer program comprising instructions which when executed on at least one processor of the network node, cause the at least said one processor to carry out the method steps presented herein.

A carrier is also provided containing the computer program, wherein the carrier is one of a computer readable storage medium; an electronic signal, optical signal, or a radio signal.

Advantages achieved by the embodiments of the present invention include significantly reducing the feedback overhead and the computational complexity at the wireless device for codebook-based CSI reporting.

### BRIEF DESCRIPTION OF THE DRAWINGS

Embodiments of the present invention are now described in further detail with reference to the accompanying drawings, in which:

FIG. 1 shows a schematic representation of a wireless communications system;

FIG. 2 shows a block-based model of a MIMO DL transmission using codebook-based-precoding in accordance with LTE Release 8;

FIG. 3 is a schematic representation of a wireless communications system for communicating information between a transmitter and a plurality of receivers, wherein embodiments herein may be employed;

FIG. 4 illustrates a flowchart of a method performed by a wireless device (or UE) according to some embodiments herein;

FIG. 5 illustrates a flowchart of a method performed by a network node according to some embodiments herein;

FIG. 6 is a block diagram depicting a wireless device according to some embodiments herein;

FIG. 7 is a block diagram depicting a network node according to some embodiments herein.

### DETAILED DESCRIPTION

In the following, a detailed description of the exemplary embodiments is described in conjunction with the drawings, in several scenarios to enable easier understanding of the solution(s) described herein.

To overcome the problems previously mentioned with regards the state of the art, the invention of the present disclosure proposes extensions to the NR Type-II CSI reporting to allow time-domain based downlink precoding for time-varying multipath propagation channels. Compared to the state of the art CSI reporting schemes, it is proposed to extend the CSI reporting schemes by one or more components (for example one or more Doppler component(s) or one or more time domain component(s) included in a new basis set of the codebook) that allows a wireless device or network node to perform time-domain-based CSI compression, CSI prediction and reporting used for precoding of downlink signals. Moreover, such components (e.g. Doppler or time-domain components) of the CSI report drastically reduce the CSI overhead over time as the CSI describes the channel evolution over time in a compact manner. Based on these findings, a new CSI Type-II reporting (a Doppler-based or time-domain-based codebook extension) scheme for NR systems that overcome the aforementioned drawbacks is proposed. For the new Doppler-based or time-domain-based Type-II CSI reporting scheme, the 3GPP Rel. 15 and Rel. 16 UCI or CSI omission procedures cannot be reused, since e.g., subband-based PMI as in 3GPP Rel. 15 does not exist and a decomposition into a number of subband PMIs is not possible. Therefore, this invention according to the present embodiment addresses the previously described drawbacks. In detail, several UCI or CSI methods and procedures for a new Doppler-based Type-II codebook and CSI reporting are proposed.

### Precoder Structure and CSI Reporting

It should be noted that the term “precoding” equally means “precoder”. Hence, throughout this disclosure precoding and precoder are used interchangeably.

The term ‘beam’ is used to denote a spatially selective/directive transmission of an outgoing signal or reception of an incoming signal which is achieved by precoding/filtering the signal at the antenna ports of the device (UE or gNB) with a particular set of coefficients. The words precoding or precoder or filtering may refer to processing of the signal in the analog domain or in the digital domain. The set of coefficients used to spatially direct a transmission/reception in a certain direction may differ from one direction to another direction. The term ‘Tx beam’ denotes a spatially selective/directive transmission and the term ‘Rx beam’ denotes a spatially selective/directive reception. The set of coefficients used to precode/filter the transmission or reception is denoted by the term ‘spatial filter’. The term ‘spatial filter’ is used interchangeably with the term ‘beam direction’ in this document as the spatial filter coefficients determine the direction in which a transmission/reception is spatially directed to.

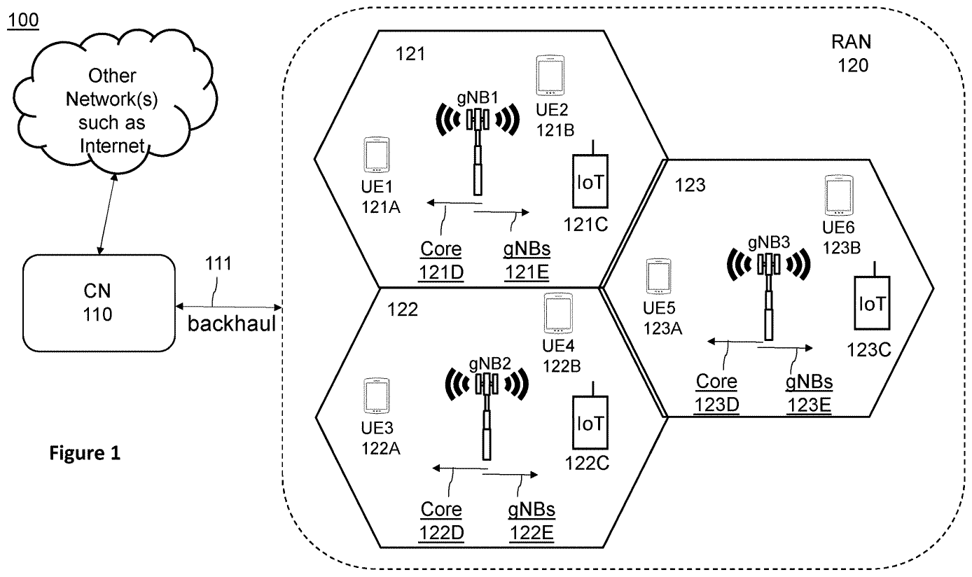

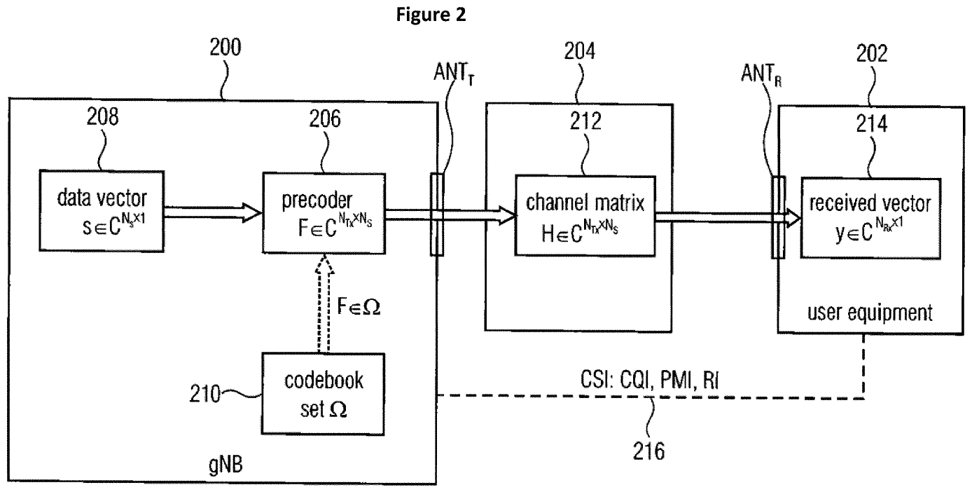

Exemplary embodiments of the present invention may be implemented in a wireless communications system or network as depicted in FIG. 1 or FIG. 2 including transmitters or transceivers, like base stations, and communication devices (receivers) or users, like mobile or stationary terminals or IoT devices or UEs, as mentioned earlier in the background part of this disclosure.

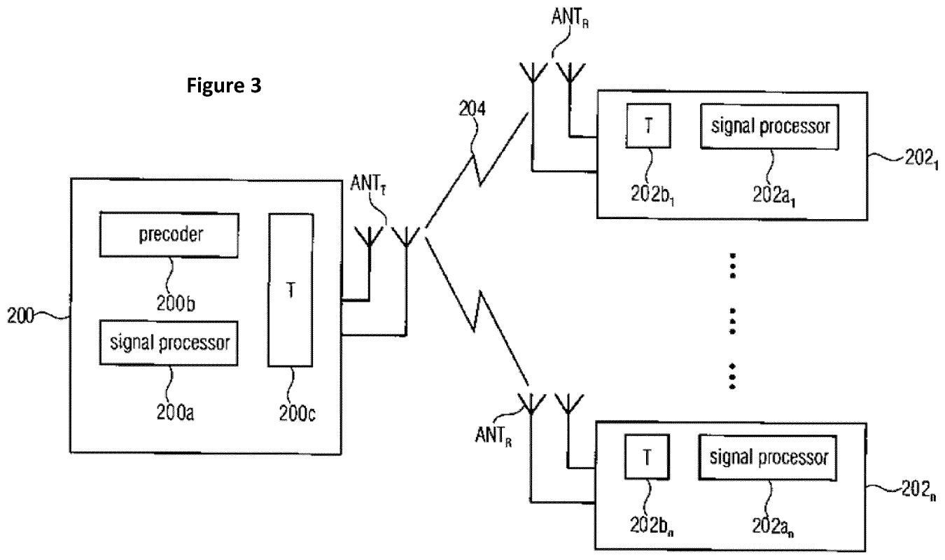

Referring to FIG. 3, there is depicted a schematic representation of a wireless communications system for communicating information between a transmitter 200, like a base station or a gNB, and a plurality of wireless devices 202₁ to 202ₙ, like UEs, which are served by the network node, like a base station 200. The network nodes 200 and the UEs 202 may communicate via a wireless communication link or channel 204, like a radio link. The network node 200 includes one or more antennas ANT_{T} or an antenna array having a plurality of antenna elements, and a signal processor 200a. The UEs 202 include one or more antennas ANT_{R} or an antenna array having a plurality of antennas, a signal processor 202a₁, 202aₙ, and a transceiver 202b₁, 202bₙ. The base station 200 and the respective UEs 202 may operate in accordance with the inventive teachings described herein.

According to embodiments herein, the wireless device is configured to generate a CSI report about a radio channel between the wireless device and a network node, e.g., a gNB in a wireless communications system. The radio channel may be a MIMO channel.

The wireless device mentioned above may include one or more of the following: a UE, or a mobile terminal, or a stationary terminal, or a cellular IoT-UE, or a vehicular UE, or a vehicular group leader (GL) UE, or an IoT, or a narrowband IoT, NB-IoT, device, or a WiFi non Access Point STAtion, non-AP STA, e.g., 802.11ax or 802.11be, or a ground based vehicle, or an aerial vehicle, or a drone, or a moving base station, or a road side unit, or a building, or any other item or device provided with network connectivity enabling the item/device to communicate using the wireless communication network, e.g., a sensor or actuator, or a macro cell base station, or a small cell base station, or a central unit of a base station, or a distributed unit of a base station, or a relay, or a remote radio head, or an AMF, or an SMF, or a core network entity, or mobile edge computing entity, or a network slice as in the NR or 5G core context, or any transmission/reception point, TRP, enabling an item or a device to communicate using the wireless communication network, the item or device being provided with network connectivity to communicate using the wireless communication network. A receiver may be a network node or gNB or a base station. Vice versa, a transmitter may be viewed as a radio base station or a network node or gNB, whereas a receiver may be a UE.

In general, and in accordance with some non-limiting exemplary effects achieved by the embodiments herein include a wireless device receiving from a network node or gNB a CSI report configuration via a higher layer (e.g., RRC) indicating one or more antenna port groups or CSI-RS resources associated with one or more antenna or CSI-RS ports used by the wireless device for CSI measurements. An antenna port group may comprise or indicate a number of antenna or CSI-RS ports and is associated with specific set of time- and frequency-domain resources of the DL channel. In some examples, an antenna port group is a CSI-RS resource that comprises or indicates a number of antenna or CSI-RS ports. The wireless device or user equipment may be configured (via the CSI report configuration) with multiple antenna port groups (e.g., multiple CSI-RS resources). Such a configuration is called as CSI-RS burst in the following. Note that, in some examples, the wireless device may be configured with multiple antenna port groups, wherein each antenna port group indicates one or more antenna or CSI-RS ports and all antenna port groups are associated with or are included in a single CSI-RS resource or in multiple CSI-RS resources. In some examples, the wireless device may be configured with N antenna port groups, wherein N=2 or N>2. The CSI-RS ports of the configured antenna port groups may be identical or different. In certain embodiments, the antenna port groups configured to the wireless device are associated with different time domain resources or time domain occasions of the DL channel. The CSI report configuration may also comprise the parameters N₁ and N₂ indicating the number of antenna or CSI-RS ports for a first dimension and second dimension, respectively.

### Precoder Description

In a certain embodiment, the wireless device determines a precoder or precoder vector or matrix for RI transmission layers and indicates the precoder or precoder vector or matrix in the CSI report. Each precoder vector or matrix of the plurality of precoder vectors or matrices is represented by a linear combination of spatial-domain components, frequency-domain components and time-domain components, and a set of combining/combination coefficients for combining the spatial-domain components, frequency-domain components and time-domain components as described herein. The plurality of precoder vectors or matrices may be indicated in the CSI report by indicating the spatial-domain components, frequency-domain components and time-domain components and the set of linear combination coefficients.

The term ‘combination coefficient’ and the term ‘combining coefficient’ in this disclosure can be used interchangeably.

The precoder vectors or matrices may be defined over a number of subbands, N₃, and time instances, N₄. The bandwidth of the DL channel may be divided into a number of subbands, wherein each precoder vector or matrix is associated with a sub-band. In certain embodiments, the number of subbands of the precoder is an integer number (or a real number smaller than 1) of the number of CQI subbands configured to the wireless device. The number of CQI subbands may be indicated to the wireless device via the CSI report configuration.

Each precoder vector or matrix may also be associated with a time instant of the DL channel. In some examples, the number of time-instances, N₄, the precoder is associated with may be configured to the wireless device from the network node via a higher layer (e.g., RRC), or it is derived from another parameter, or it is selected by the wireless device and reported to the network node.

The precoder vectors or matrices are determined by the wireless device based on measurements of the received reference signals (e.g., CSI-RS), wherein the reference signals are provided by another wireless device or the network node. The reference signals are configured to the wireless device via the CSI report configuration. The wireless device is configured to perform CSI measurements on the antenna port groups (ie., on the CSI-RS burst) and to determine based on the CSI measurements the precoder vectors or matrices for a number of future slots or time instances, and to indicate the precoder vectors or matrices in the CSI report. The number of future slots or time instances may be configured to the wireless device from the network node.

The wireless device may perform the measurements on the CSI-RS ports over multiple time instances (e.g., OFDM symbols, or slots, or frames). In certain embodiments, the number of time instances may correspond to the size (or length) of a basis vector in a third basis set (see below). In certain embodiments, the number of time instances may correspond to the number of antenna port groups or CSI-RS resource(s) configured to the wireless device to determine the precoder vectors or matrices. In certain embodiments, the number of slots or time-instances is indicated to the wireless device, e.g., via a higher layer, or is fixed in the NR specifications and known by the wireless device, or selected by the wireless device and indicated in the CSI-report. The wireless device generates and transmits the CSI report indicating the precoder vector or matrix via an uplink channel to a network node, gNB, or another wireless device.

### Spatial-Domain Components of the Precoder

In certain embodiments, the wireless device is configured to determine one or more spatial domain, SD, components for the set of linear combination coefficients of the precoder. Each SD component corresponds to a basis vector. A set of SD components may correspond to a first basis set. For determining the precoder vectors or matrices, the wireless device is configured to select one or more SD components from the first basis set. A basis vector from the first basis set is associated with a set of antenna ports or CSI-RS ports of an antenna port group. The set of antenna ports or CSI-RS ports may be associated with a first and second polarization. A first set of antenna or CSI-RS ports may be associated with a first polarization, and a second set of antenna or CSI-RS ports may be associated with a second polarization. The selection of the one or more basis vectors (one or more SD components) from the first basis set can be polarization-common or polarization-specific. In case of polarization-common selection, the selected basis vectors from the first basis set are common to the two polarizations of the antenna or CSI-RS ports configured to the wireless device. In case of polarization-specific selection, the selected basis vectors from the first set are independently selected by the wireless device for the two polarizations of the antenna or CSI-RS ports configured to the wireless device. In an exemplary embodiment, the wireless device selects L basis vectors of the precoding vector or matrix from the first basis set, and indicates the selected L basis vectors in the CSI report. In some examples, the selected L basis vectors are polarization-common, and hence identical for the first and second set of antenna or CSI-RS ports. In some examples, the selected L basis vectors are polarization-dependent, and hence possibly different to the first or second set of antenna or CSI-RS ports. In some examples, the selected L basis vectors are layer-dependent and differ for a subset of transmission layers or per transmission layer of the precoder. In such a case, the basis vectors are selected independently per layer subset or layer of the precoder. In some other examples, the selected L basis vectors are layer-independent and identical for all layers of the precoder.

In certain embodiments, the first basis set is an orthogonal basis set, i.e., the basis set comprises a number of orthogonal basis vectors. For example, the first basis set is a DFT- or DCT-based basis set. In certain embodiments, the first basis set is defined by an DFT or IDFT basis set, or an oversampled DFT or IDFT basis set. In certain embodiments, the first basis set comprises a set of Discrete Cosine Transform (DCT)-based vectors. When the first basis set is defined by an DFT-based (DFT or IDFT) basis set, the first basis set is represented by a DFT- or IDFT-matrix. In certain embodiments, the first basis set is defined by a rotated DFT-based basis, wherein the indices of the DFT-based vectors are defined by i₁=O₁i₁₁+q₁, i₁₁=0, . . . , N₁−1, i₂=O₂i₂₂+q₂, i₂₂=0, . . . , N₂−1 with q₁=0, . . . , O₁−1 q₂=0, . . . , O₂−1 be the rotation factors of the rotated DFT-based basis, N₁ and N₂ denote the antenna ports with respect to a first and a second dimension, respectively, and O₁ and O₂ denote the oversampling factors with respect to the first and second dimension, respectively. In such cases, the rotated DFT-based basis is selected from an oversampled DFT-based basis comprising O₁O₂N₁N₂ DFT-based vectors. The rotation factors may be selected by the wireless device, or configured to the wireless device, or reported by the wireless device as a part the CSI-report. The oversampling factors may be configured to the wireless device.

In certain embodiments, the first basis set is an orthogonal basis set, i.e., the basis set comprises a number of orthogonal basis vectors comprising an identity matrix. Each vector of size P_{CSI-RS} or P_{CSI-RS}/2 from the basis set is associated with a CSI-RS port and comprises P_{CSI-RS}−1 or

$$\frac{{P}_{CSI - RS}}{2} - 1$$

zeros and a single one, wherein P_{CSI-RS} or P_{CSI-RS}/2 (e.g., per polarization of the antenna ports) is the number of antenna ports of one or multiple antenna port groups.

### Frequency-Domain Components of the Precoder

In certain embodiments, the wireless device is configured to determine one or more frequency domain, FD, components for the set of linear combination coefficients of the precoder. Each frequency-domain, FD, component of the precoder corresponds to a basis vector. A set of FD components corresponds to a second basis set. For determining the precoder vectors or matrices, the wireless device is configured to select one or more FD components (i.e., basis vectors) from the second basis set. A basis vector from the second basis set is associated with a number of subbands, N₃, of the bandwidth of the DL channel. A subband may comprise a number of Physical Resource Blocks (PRBs). In certain embodiments, the number of subbands, N₃, is dependent on the number of CQI subbands, or on the CQI subband size configured to the wireless device.

In certain embodiments, the second basis set is defined by an orthogonal basis set, i.e., the basis set comprises a number of orthogonal vectors. For example, the second basis set is a DFT- or DCT-based basis. In certain embodiments, the second basis set is defined by an DFT or IDFT basis, or an oversampled DFT or IDFT basis. In certain embodiments, the second basis set comprises a set of Discrete Cosine Transform (DCT)-based vectors. When the second basis set is defined by an DFT-based (DFT or IDFT) basis, the second basis set may be represented by a DFT- or IDFT-matrix. In certain embodiments, the second basis set is defined by a rotated DFT-based basis, wherein the indices of the DFT-based vectors are defined by d₃=O₃i₃+q₃, i₃=0, . . . , N₃−1 with q₃=0, . . . , O₃−1 be the rotation factor of the rotated DFT-based basis. In such cases, the rotated DFT-based basis is selected from an oversampled DFT-based basis comprising O₃N₃ DFT-based vectors. This means, the basis set corresponding to the frequency-domain components is an oversampled DFT- or DCT-based matrix comprising O₃ orthogonal DFT- or DCT-based matrices. The rotation factor may be selected by the wireless device, or configured to the wireless device, or reported by the wireless device as a part the CSI-report. In certain embodiments, the number of frequency subbands defines the length (N₃) of the basis vectors of the second basis set. The number of frequency subbands may be indicated to the wireless device, e.g., via a higher layer, or may be fixed in the NR specifications and known by the wireless device or selected by the wireless device and indicated in the CSI-report.

In certain embodiments, the set of FD components is a basis set represented by DFT-based or DCT-based matrix or an oversampled DFT-based or DCT-based matrix, and the basis set comprises a number of basis vectors that represent the FD components, and each basis vector is a DFT- or DCT-based vector.

In certain embodiments, the basis vector set of the FD components is an oversampled DFT- or DCT-based matrix comprising O₃ orthogonal DFT- or DCT-based matrices.

### Time-Domain Components of the Precoder

In certain embodiments, the wireless device is configured to determine one or more time domain components for the set of linear combination coefficients of the precoder. Each time-domain component of the precoder corresponds to a basis vector. The set of time-domain components corresponds to a third basis (vector) set comprising a number of basis vectors.

For determining the precoder vectors or matrices, the wireless device is configured to select one or more time-domain components (i.e., basis vectors) from the third basis set. In some examples, the length of the basis vectors (i.e., the number of entries of each basis vector) is defined by an integer number of the antenna port groups (as described above) configured to the wireless device. In some examples, the length of the basis vectors (i.e., the number of entries of each basis vector) is configured to the wireless device by a network node.

The wireless device is configured to perform measurements on the reference signals (i.e., on the configured antenna port groups) received by the wireless device over N₄ time instances. Note that a time-instance of the DL channel may be associated with an OFDM symbol, or a set of symbols, or a slot or a radio frame.

In certain embodiments, the third basis set comprises a number of basis vectors. The third basis set may be defined by a DFT or IDFT basis, or an oversampled DFT or IDFT basis. In certain embodiments, the third basis set comprises a set of Discrete Cosine Transform (DCT)-based vectors. When the third basis set is defined by a DFT-based (DFT or IDFT) basis, the third basis set may be represented by a DFT- or IDFT-matrix. In certain embodiments, the third basis set is defined by a rotated DFT-based basis, wherein the indices of the DFT-based vectors are defined by d₄=O₄i₄+q₄, i₄=0, . . . , N₄−1 with q₄=0, . . . , O₄−1 be the rotation factor of the rotated DFT-based basis. In such cases, the rotated DFT-based basis is selected from an oversampled DFT-based basis comprising O₄N₄ DFT-based vectors. This means, the basis set corresponding to the time-domain components is an oversampled DFT- or DCT-based matrix comprising O₄ orthogonal DFT- or DCT-based matrices. The rotation factor may be selected by the wireless device, or is configured to the wireless device, or is reported by the wireless device as a part of the CSI-report. In certain embodiments, the number of time-instances defines the length (N₄) of the basis vectors of the third basis set, and each entry of a basis vector is associated with a time instant of the precoder vector or matrix. When the third basis set is defined by an N₄×N₄ DFT-based (DFT- or IDFT-) matrix, the phases of the elements of each basis vector increase (or decrease) with respect to the element index. Hence, each basis vector from the third basis set is associated with a Doppler frequency in the transformed domain. The N₄ basis vectors of the third basis set are hence associated with N₄ different Doppler frequencies. The wireless device selects the basis vectors (i.e., the Doppler frequencies) for the precoder based on the measured reference signals.

### Selection of Basis Vectors and Indication in CSI Report

In certain embodiments, the wireless device determines a set of combining coefficients for combining the selected SD component(s), TD component(s) and FD component(s) for the precoder. The wireless device generates and transmits, to a network node or other wireless device, a CSI report, the CSI report comprising an indication of the selected one or more SD components, an indication of the selected one or more TD components and an indication of the selected one or more FD components, and an indication of the combining coefficients of the precoder vector or matrix.

In certain embodiments, the set of SD components corresponding to the first basis set comprising O₁O₂N₁N₂ basis vectors, the set of FD components corresponding to the second basis set comprising N₃ basis vectors, and the set of TD components corresponding to the third basis set comprising N₄ basis vectors. The wireless device selects out of the O₁O₂N₁N₂ basis vectors, L basis vectors from the first basis set, wherein L<O₁O₂N₁N₂. The wireless device selects M out of N₃ basis vectors from the second basis set, wherein M≤N₃ or M<N₃. The wireless device selects Q basis vectors out of N₄ basis vectors from the third basis set, wherein Q≤N₄, or <N₄.

In certain embodiments, the wireless device selects a number of basis vectors (e.g., L basis vectors) from the first basis set, wherein the first basis set corresponds to the set of SD components, and the number of selected basis vectors is smaller than the number of basis vectors of the first basis set. The selected basis vectors are indicated in the CSI report. In some examples, the selected basis vectors are indicated by a bitmap or by a combinatorial bit indicator

$$( e . g . , by a ⌈ {log}_{2} ( \begin{matrix}{N}_{1} {N}_{2} \\ L\end{matrix} ) ⌉ bit indicator , or thereof ) .$$

In certain embodiments, the wireless device selects a number of basis vectors (i.e., M basis vectors) from the second basis set, wherein the number of selected basis vectors is smaller than the number of basis vectors of the second basis set. In certain embodiments, the selected M basis vectors (or delays) are indicated in the CSI report. In some examples, the selected basis vectors are indicated by a bitmap or a combinatorial bit indicator

$$( e . g . , a ⌈ {log}_{2} ( \begin{matrix}{N}_{3} \\ M\end{matrix} ) ⌉ or by a ⌈ {log}_{2} ( \begin{matrix}{N}_{3 - 1} \\ M - 1\end{matrix} ) ⌉ bit indicator ) .$$

In certain embodiments, the wireless device selects a number of basis vectors (i.e., Q basis vectors) from the third basis set, wherein the number of selected basis vectors is smaller than the number of basis vectors of the third basis set. In certain embodiments, the selected Q basis vectors (or Doppler frequencies) are indicated in the CSI report. In some examples, the selected basis vectors are indicated by a bitmap or a combinatorial bit indicator

$$( e . g . , a ⌈ {log}_{2} ( \begin{matrix}{N}_{4} \\ Q\end{matrix} ) ⌉ or by a ⌈ {log}_{2} ( \begin{matrix}{N}_{4 - 1} \\ Q - 1\end{matrix} ) ⌉ bit indicator ) .$$

In certain embodiments, the selected one or more basis vectors from the first, second, and third basis sets of the precoder are indicated by a bitmap in the CSI report, wherein each bit is associated with selected basis vectors from the first, second, and third basis sets and a combining coefficient of the precoder. In certain embodiments, only non-zero combining coefficients of the precoder vector or matrix are contained or indicated in the CSI report.

In certain embodiments, the number of SD components (e.g., the parameter L indicating the subset size of SD components to be selected by the wireless device) is configured to the wireless device, e.g., from a network node, or gNB, or other wireless device.

In certain embodiments, the number of FD components (e.g., the parameter M indicating the subset size of FD components to be selected by the wireless device) is configured to the wireless device, e.g., from a network node, or gNB, or other wireless device.

In certain embodiments, the number of TD components (e.g., the parameter Q indicating the subset size of SD components to be selected by the wireless device) is configured to the wireless device, e.g., from a network node, or gNB, or other wireless device.

### Precoder Matrix

In certain embodiments, the precoder vector or matrix of a transmission layer and associated with the two polarizations of the antenna ports is given by

$${W}_{t , h} = \{ \begin{matrix}{{\sum }_{l = 0}}^{L - 1} {v}_{l} {{\sum }_{f = 0}}^{M - 1} {{\sum }_{n = 0}}^{Q - 1} {c}_{l , f , n} {y}_{t , l}^{( f )} {x}_{h , l}^{( n )} , \\ {{\sum }_{l = 0}}^{L - 1} {v}_{l + L} {{\sum }_{f = 0}}^{M - 1} {{\sum }_{n = 0}}^{Q - 1} {c}_{l + L , f , n} {y}_{t , l + L}^{( f )} {x}_{h , l + L}^{( n )} ,\end{matrix}$$

where
vₗ denotes a basis vector selected from the first basis set (the set of spatial domain components) and corresponds to a spatial-domain component of the precoder,
c_{l,f,n} denotes the complex combining coefficient associated with the 1-th selected spatial-domain component, f-th frequency-domain component, and n-th time-domain component of the precoder vector or matrix,

$${y}_{t , l}^{( f )} = {e}^{\sqrt{- 1} \frac{2 π {tn}_{3 , l}^{( f )}}{{N}_{3}}} or {y}_{t , l}^{( f )} = {e}^{- \sqrt{- 1} \frac{2 π {tn}_{3 , l}^{( f )}}{{N}_{3}}}$$

is the t-th (t=0, 1, . . . , N₃−1) component/entry of the

$${n}_{3 , l}^{( f )} - th$$

basis vector/frequency-domain component selected from the second basis set associated with the frequency-domain components of the precoder, and

$${x}_{h , l}^{( n )} = {e}^{\sqrt{- 1} \frac{2 π h {n}_{4 , l}^{( n )}}{{N}_{4}}} or {x}_{h , l}^{( n )} = {e}^{- \sqrt{- 1} \frac{2 π h {n}_{4 , l}^{( n )}}{{N}_{4}}}$$

is the h-th (h=0, 1, . . . , N₄−1) component/entry of the

$${n}_{4 , l}^{( n )} - th$$

basis vector/time-domain component selected from the third basis set associated with the time-domain components of the precoder.

### UCI Omission

Uplink control information, UCI, omission occurs when the uplink resources provided by a base station or by a network node to the wireless device or user equipment for an uplink transmission is not sufficient to carry the entire content of one or more CSI report(s). The CSI payload of a CSI report can be controlled by the UE by the number of precoder coefficients to be reported. In case of UCI or CSI omission, the UE can simply reduce the number of precoder coefficients to be reported for one or more of the CSI reports based on the available uplink resources (e.g., available PUSCH resources). However, such a reduction of the number of precoder combining coefficients would require a recalculation of the precoder coefficients, all basis vectors associated with the precoder vector or matrix for the one or more CSI reports, occupying additional UE resources. Such additional UE resources may not be available at the UE. Therefore, a UCI omission scheme should not require a recalculation of precoder vector or matrix for the one or more CSI reports.

In accordance with embodiments, the uplink resource or uplink control information (UCI) may contain the one or more reduced-size CSI report(s), wherein the UCI may comprise a UCI or CSI part 1 and a UCI or CSI part 2. In some examples, the UCI or CSI part 1 may comprise an indication of the number of precoder (amplitude and/or phase) combining coefficients per layer or across all layers of the precoder vector or matrix for the one or more CSI report(s). In some examples, the UCI or CSI part 1 may comprise a rank indication or a rank index (RI) for the one or more CSI report(s) indicating the number of layers of the precoder vector or matrix in the CSI report.

In accordance with embodiments, the UE is configured to receive an uplink resource allocation from a base station for an uplink transmission of one or more CSI reports. The UE may determine that the size of the resource allocation is not sufficient to carry the entire content(s) of the CSI report(s). In such cases, the UE may perform a CSI or UCI omission procedure to determine one or more reduced-size CSI report(s) that fit within the uplink resource allocation. The one or more reduced-size CSI report(s) may be transmitted over an uplink channel to a network node, like a base station, gNB.

In one embodiment, the CSI omission procedure is based on dropping a portion of the amplitude and phase coefficients of the precoder or combining coefficients of the one or more CSI report(s). This means the UE is configured to omit a portion of the one or more CSI report(s), and thereby provide one or more reduced-size CSI report(s) for the transmission over an uplink channel to a network node, like a base station, gNB.

In accordance with embodiments, the set of combining coefficients are segmented for each CSI report into two or more CSI groups for UCI or CSI omission, wherein for the combining coefficients a certain ordering is applied and the combining coefficients are segmented or divided into two or more CSI groups. Moreover, each CSI report and each CSI group may be associated with a priority level.

In one embodiment, the CSI or UCI omission procedure is based on dropping one or more CSI groups and hence the associated phase and amplitude of the combining coefficients of the precoder vector or matrix of the associated CSI report according to a priority rule. Hence, in case of CSI or UCI omission, a part of the amplitude and/or phase coefficients of the precoder vector or matrix indicated in the CSI report is omitted.

In accordance with embodiments, the UE may drop the CSI groups in case of UCI or CSI omission with lower priority until the payload size of the CSI report(s) fits with the resource allocation from the network node, like a base station, gNB. When omitting a CSI group for a particular priority level, the UE may omit all the CSI content at that priority level.

In the following embodiments, ordering schemes for the bits in the bitmap and hence the combining coefficients are proposed. It is assumed that the ordering for the combining coefficients in the at least two CSI groups follows the ordering of the bits of the bitmap. The aim of the ordering of the combining coefficients is to reduce performance degradation in case of UCI or CSU omission, i.e., when one or more CSI groups are dropped from a CSI report.

### CSI Report Configuration

In certain embodiments, the wireless device is configured to select M FD components for the precoding matrix and to indicate the selected M FD components in the CSI report.

In certain embodiments, the wireless device is configured to select Q TD components for the precoding matrix and to indicate the selected Q FD components in the CSI report.

In certain embodiments, the wireless device is configured to select L SD components for the precoding matrix and to indicate the selected L SD components in the CSI report. Note that the SD components are identical for both polarizations of the antenna ports. Hence, the precoding matrix is associated with 2L SD components, where the L SD components are identical for both polarizations.

In certain embodiments, the wireless device selects 2LMQ combining coefficients, where L is a number of spatial-domain, SD, components, M is a number of frequency-domain, FD, components, and Q is a number of time-domain, TD, components. The number of SD, FD and TD components are either selected and reported by the wireless device, or higher layer configured (e.g., via RRC) to the UE, or fixed in the specification and known to the wireless device.

To reduce the feedback overhead, the wireless device may be configured to determine K or less than K non-zero combining coefficients out of the 2LMQ combining coefficients. The K non-zero combining coefficients are reported (as a part of the CSI report) by the wireless device to a network node (e.g., gNB). The value of K is configured to the wireless device, fixed in the 3GPP specifications and hence known to the wireless device, or selected and reported from the wireless device to a network node.

In certain embodiments, the wireless device determines a bitmap of size 2LMQ indicating the location of the selected non-zero combining coefficients. The bitmap comprises 1's and 0's. A ‘1’ is associated with a selected non-zero combining coefficient and a ‘0’ is associated with a zero or non-selected combining coefficient, or vice versa. In some examples, the bitmap is selected per layer of the precoding matrix. The bitmap is a part of the CSI report.

In certain embodiments, the wireless device is configured to indicate in the CSI report the location of the selected non-zero coefficients using a

$$⌈ {log}_{2} ( \begin{matrix}2 LMQ \\ K\end{matrix} ) ⌉ - bit indicator .$$

In certain embodiments, the wireless device is configured to determine S FD-TD component pairs commonly across a subset of SD components or all SD components of the precoding matrix. An FD-TD component pair is defined as a pair comprising a FD component and a TD component. In some examples, the S FD-TD component pairs are selected commonly across all SD components per layer, a subset of layers or all layers of the precoding matrix. The number of combining coefficients (zero and non-zero combining coefficients) equals then to 2LS per layer of the precoding matrix. Note that multiple combining coefficients associated with different SD components can be associated with the same FD-TD component pair.

Furthermore, the wireless device may be configured to determine K or less than K non-zero combining coefficients out of the 2LS combining coefficients. The non-zero combining coefficients are reported as a part of the CSI report by the wireless device to the network node (e.g., gNB). For indicating the selected non-zero combining coefficients out of the 2LS combining coefficients, the wireless device reports a bitmap of size 2LS per layer, subset of layers, or for all layers of the precoding matrix in the case of polarization-specific combining coefficient selection. As the bitmap has only a size of 2LS instead of 2LMQ, the CSI reporting overhead is significantly reduced.

In certain embodiments, S is less than MQ, where M is the number of configured FD components of the precoding matrix, and Q is the number of configured TD components of the precoding matrix.

In certain embodiments, the parameter, S, indicating the number of FD-TD component pairs is configured via a higher layer (e.g., RRC) to the wireless device from a network node. The value of S can be configured per layer, subset of layers, or commonly for all layers of the precoding matrix. In certain embodiments, the parameter, S, indicating the number of FD-TD component pairs is derived from one or more other parameters which are either configured to the wireless device or fixed in the 3GPP specifications. In one example, S, is derived from the parameter M, where M is the number of configured FD components of the precoding matrix.

In another example, S=M. In another example, S, is derived from the parameter Q, where Q is the number of configured TD components of the precoding matrix. In another example, S, is derived from the parameters M and Q, where M is the number of FD components, and Q is the number of TD components. In some examples, M is configured to the wireless device from the network node, or the parameters M and Q are configured to the wireless device from a network node. In some examples, the value of S is reported by the wireless device per layer, subset of layers, or for all layers of the precoding matrix to the network node as a part of the CSI report. In some examples, the value of S is reported by the wireless device using a ┌log₂ MQ┐-bit indicator.

In certain embodiments, the wireless device is configured to determine S SD-TD component pairs commonly across a subset of FD components or all FD components of the precoding matrix. An SD-TD component pair is defined as a pair comprising a SD component and a TD component. In some examples, the S SD-TD component pairs are selected commonly across all FD components per layer, a subset of layers or all layers of the precoding matrix. The number of combining coefficients (zero and non-zero combining coefficients) equals to MS per layer. Note that multiple combining coefficients associated with different FD components can be associated with the same SD-TD component pair.

Furthermore, the wireless device is configured to determine K or less than K non-zero combining coefficients out of the MS combining coefficients. The non-zero combining coefficients are reported as a part of the CSI report by the wireless device to the network node (e.g., gNB). For indicating the selected non-zero combining coefficients out of the MS combining coefficients, the wireless device reports a bitmap of size MS per layer, subset of layers, or for all layers of the precoding matrix in the case of polarization-specific combining coefficient selection. As the bitmap has only a size of MS instead of 2LMQ, the CSI reporting overhead is significantly reduced.

In certain embodiments, the number, S, of SD-TD component pairs is less than 2LQ, where L is the number of configured SD components of the precoding matrix per polarization, and Q is the number of configured TD components of the precoding matrix.

In certain embodiments, the number, S, of SD-TD component pairs is configured via a higher layer (e.g., RRC) to the wireless device from a network node. The value of S can be configured per layer, subset of layers, or commonly for all layers of the precoding matrix. In certain embodiments, the number, S, of SD-TD component pairs is derived from one or more other parameters which are either configured to the wireless device or fixed in the 3GPP specifications. In one example, S, is derived from the parameter L, where L is the number of configured SD components of the precoding matrix. In another example, S, is derived from the parameter Q, where Q is the number of configured TD components of the precoding matrix. In another example, S, is derived from the parameters L and Q, where L is the number of SD components, and Q is the number of TD components. In some examples, L is configured to the wireless device from the network node, or the L and Q are configured to the wireless device from a network node. In some examples, the value of S is reported by the wireless device per layer, subset of layers, or for all layers of the precoding matrix to the network node as a part of the CSI report. In some examples, the value of S is reported by the wireless device using a ┌log₂ 2LQ┐-bit indicator.

In certain embodiments, the wireless device is configured to determine S SD-FD component pairs commonly across a subset of TD components or all TD components of the precoding matrix. An SD-FD component pair is defined as a pair comprising a SD component and a FD component. In some examples, the S SD-FD component pairs are selected commonly across all TD components per layer, a subset of layers or all layers of the precoding matrix. The number of combining coefficients (zero and non-zero combining coefficients) equals to QS per layer. Note that multiple combining coefficients associated with different TD components can be associated with the same SD-FD component pair.

Furthermore, the wireless device is configured to determine K or less than K non-zero combining coefficients out of the QS combining coefficients. The non-zero combining coefficients are reported as a part of the CSI report by the wireless device to the network node (e.g., gNB). For indicating the selected non-zero combining coefficients out of the QS combining coefficients, the wireless device reports a bitmap of size QS per layer, subset of layers, or for all layers of the precoding matrix in the case of polarization-specific combining coefficient selection. As the bitmap has only a size of QS instead of 2LMQ, the CSI reporting overhead is significantly reduced.

In certain embodiments, the number, S, of SD-FD component pairs is less than 2LM, where M is the number of configured FD components of the precoding matrix and L is the number of configured SD components of the precoding matrix per polarization.

In certain embodiments, the number, S, of SD-FD component pairs is configured via a higher layer (e.g., RRC) to the wireless device from a network node. The value of S can be configured per layer, subset of layers, or commonly for all layers of the precoding matrix. In certain embodiments, the number, S, of SD-FD component pairs is derived from one or more other parameters which are either configured to the wireless device or fixed in the 3GPP specifications. In one example, S, is derived from the parameter L, where L is the number of configured SD components of the precoding matrix. In another example, S, is derived from the parameter M, where M is the number of configured FD components of the precoding matrix.

In another example, S, is derived from the parameters L and M, where L is the number of SD components, and M is the number of FD components. In some examples, L is configured to the wireless device from the network node, or the L and M are configured to the wireless device from a network node. In some examples, the value of S is reported by the wireless device per layer, subset of layers, or for all layers of the precoding matrix to the network node as a part of the CSI report. In some examples, the value of S is reported by the wireless device using a ┌log₂ 2LM┐-bit indicator.

### Ordering of Bitmap in CSI Report

### Option 1:

In certain embodiments, the wireless device generates a bitmap comprising RI bit fields, wherein the r-th bit field comprises 2LS bits. Each bit in the r-th bit field is associated with one SD component out of the L SD components and with a FD-TD component pair out of the S FD-TD component pairs. The RI bit fields are associated with RI layers of the precoding matrix and the RI bit fields with indices r={0, . . . , RI−1}, are ordered in an increasing order from left to right. The ordering of the bits associated with the r-th layer in the r-th bit field and the associated combining coefficients of the precoding matrix is explained in the following more in detail. Note that the ordering of the combining coefficients associated with the r-th layer of the precoding matrix follows the ordering of the bits of the r-th bit field.

In the following embodiments, it is always assumed that each bit is associated with a combining coefficient, wherein a ‘0’ indicates that the associated combining coefficient is not reported and a ‘1’ indicates that the associated combining coefficient is reported. The ordering of the bits in each bit field is hence identical to the ordering of the combining coefficients associated with the bits of the bit field. Note that the definition of the bit field may change as explained in the embodiments below.

In this embodiment, it is assumed that each combining coefficient of an r-th layer of the precoding matrix is associated with the two indices (l,s), wherein 1 is an SD index and s is an FD-TD component pair index, and l=0, . . . , 2L−1, and s=0, . . . , S−1, and the ordering of the indices u, u=0, . . . , 2LS−1 associated with the bits of the r-th bit field and the combining coefficients follows one of the following schemes. Examples for the mapping from indices (l,s) to index u are explained in the following. In one scheme, the ordering of the indices u, u=0, . . . , 2LS−1 associated with the bits of the r-th bit field is a function of indices (l,s) and given by u=2Ls+l, where s={0, . . . , S−1} and l={0, . . . , 2L−1}. In another scheme, the ordering of the indices u, u=0, . . . , 2LS−1 associated with the bits of the r-th bit field is a function of indices (l,s) and given by u=S1+s, where s={0, . . . , S−1} and l={0, . . . , 2L−1}.

In a first example, the mapping between the associated FD and TD component to the s-th FD-TD component pair per layer is given by s=Qm+q, where q∈{0, . . . , Q−1} is the TD component index and m∈{0, . . . , M−1} is the FD component index. In a second example, the mapping between the associated FD and TD component to the s-th FD-TD component pair per layer is given by s=Mq+m, where q∈{0, . . . , Q−1} is the TD component index and m∈{0, . . . , M−1} is the FD component index.

### Option 2:

In certain embodiments, the wireless device generates a bitmap comprising RI bit fields, wherein the r-th bit field comprises MS bits. The RI bit fields are associated with the RI layers and the RI bit fields with indices r={0, . . . , RI−1}, are ordered in an increasing order from left to right. The ordering of the bits associated with the r-th bit field is based on one of the following ordering schemes. Here, it is assumed that each combining coefficient of an r-th layer of the precoding matrix is associated with the two indices (m,s), wherein m=0, . . . , M−1, and s=0, . . . , S−1, and the ordering of the indices u, u=0, . . . , MS−1 associated with the bits of the r-th bit field and the combining coefficients follows one of the following schemes. Examples for the mapping from indices (m,s) to index u are explained in the following.

In one scheme, the ordering of the bits of the r-th bit field is given by u=Ms+m, where s={0, . . . , S−1} and m={0, . . . , M−1}. In another scheme, the ordering of the bits of the r-th bit field is given by u=Sm+s, where s={0, . . . , S−1} and m={0, . . . , M−1}.

In a first example, the mapping between the associated SD and TD component to the s-th SD-TD component pair per layer is given by s=2Lq+l, where q∈{0, . . . , Q−1} is the TD component index and l∈{0, . . . , 2L−1} is the SD component index. In a second example, the mapping between the associated FD and TD component to the s-th SD-TD component pair per layer is given by s=Ql+q, where q∈{0, . . . , Q−1} is the TD component index and l∈{0, . . . , 2L−1} is the SD component index.

### Option 3:

In certain embodiments, the wireless device generates a bitmap comprising RI bit fields, wherein the r-th bit field comprises QS bits. The RI bit fields are associated with RI layers and the RI bit fields with indices r={0, . . . , RI−1}, are ordered in an increasing order from left to right. The ordering of the bits associated with the r-th layer in the r-th bit field is based on any one of the following ordering schemes.

In this embodiment, it is assumed that each combining coefficient of an r-th layer of the precoding matrix is associated with the two indices (q,s), wherein q=0, . . . , Q−1, and s=0, . . . , S−1, and the ordering of the indices u, u=0, . . . , QS−1 associated with the bits of the r-th bit field and the combining coefficients follows one of the following schemes. Examples for the mapping from indices (q,s) to index u are explained in the following.

In one scheme, the ordering of the bits of the r-th bit field is given by u=Qs+q, where s={0, . . . , S−1} and q={0, . . . , Q−1}. In another scheme, the ordering of the bits of the r-th bit field is given by u=Sq+s, where s={0, . . . , S−1} and q={0, . . . , Q−1}.

In a first example, the mapping between the associated SD and FD component to the s-th SD-FD component pair per layer is given by s=2Lm+l, where m∈{0, . . . , M−1} is the FD component index and l∈{0, . . . , 2L−1} is the SD component index. In a second example, the mapping between the associated SD and FD component to the s-th SD-FD component pair per layer is given by s=Ml+m, where m∈{0, . . . , M−1} is the FD component index and l∈{0, . . . , 2L−1} is the SD component index.

### Ordering of Bitmap and Combining Coefficients Across RI Layers

### Option 4:

In certain embodiments, the wireless device generates a bitmap comprising S bit fields, wherein the s-th bit field comprises 2L·RI bits, wherein RI is the rank of the precoding matrix. The S bit fields are associated with the S FD-TD component pairs across the RI layers of the precoding matrix in an increasing or decreasing order. In certain embodiments, the S bit fields with indices s={0, . . . , S−1}, are ordered in an increasing order from left to right.

The ordering of the bits in the s-th bit field associated with the s-th component pair across the RI layers is based on one of the following ordering schemes.

In this embodiment, it is assumed that each combining coefficient associated with an s-th component pair (across the RI layers) of the precoding matrix is associated with the two indices (r,l), wherein r=0, . . . , RI−1, and l=0, . . . , 2L−1, and the ordering of the indices u, u=0, . . . , 2LRI−1 associated with the bits of the s-th bit field and the indices of the combining coefficients follows one of the following schemes. Examples for the mapping from indices (r,l) to index u are explained in the following.

In one scheme, the ordering of the bits of the s-th bit field associated with the s-th component pair across the RI layers is given by u=2Lr+l, where r={0, . . . , RI−1} and l={0, . . . , 2L−1}. In another scheme, the ordering of the bits of the s-th bit field associated with the s-th component pair across the RI layers is given by u=RI·l+r, where r={0, . . . , RI−1} and l={0, . . . , 2L−1}.

In a first example, the mapping between the associated FD and TD component to the s-th FD-TD component pair per layer is given by s=Qm+q, where q∈{0, . . . , Q−1} is the TD component index and m∈{0, . . . , M−1} is the FD component index. In a second example, the mapping between the associated FD and TD component to the s-th FD-TD component pair per layer is given by s=Mq+m, where q∈{0, . . . , Q−1} is the TD component index and m∈{0, . . . , M−1} is the FD component index.

### Option 5:

In certain embodiments, the wireless device generates a bitmap comprising S bit fields, wherein the s-th bit field comprises M·RI bits. The S bit fields are associated with the S SD-TD component pairs across the RI layers of the precoding matrix in an increasing or decreasing order. In certain embodiments, the S bit fields with indices s={0, . . . , S−1}, are ordered in an increasing order from left to right.

The ordering of the bits associated with the s-th component pair in the s-th bit field is based on any one of the following ordering schemes.

In this embodiment, it is assumed that each combining coefficient associated with an s-th component pair (across the RI layers) of the precoding matrix is associated with the two indices (m,r), wherein m=0, . . . , M−1, and r=0, . . . , RI−1, and the ordering of the indices u, u=0, . . . , M·RI−1 associated with the bits of the s-th bit field and the indices of the combining coefficients follows one of the following schemes. Examples for the mapping from indices (m,r) to index u are explained in the following.

In one scheme, the ordering of the bits of the s-th bit field associated with the s-th component pair (across the RI layers) is given by u=M·r+m, where r={0, . . . , RI−1} and m={0, . . . , M−1}. In another scheme, the ordering of the bits of the s-th bit field associated with the s-th component pair (across the RI layers) is given by u=RI·m+r, where r={0, . . . , RI−1} and m={0, . . . , M−1}.

In a first example, the mapping between the associated SD and TD component to the s-th SD-TD component pair per layer is given by s=2Lq+l, where q∈{0, . . . , Q−1} is the TD component index and l∈{0, . . . , 2L−1} is the SD component index. In a second example, the mapping between the associated FD and TD component per layer to the s-th SD-TD component pair per layer is given by s=Ql+q, where q∈{0, . . . , Q−1} is the TD component index and l∈{0, . . . , 2L−1} is the SD component index.

### Option 6:

In certain embodiments, the wireless device generates a bitmap comprising S bit fields, wherein the s-th bit field comprises Q·RI bits. The S bit fields are associated with the S SD-FD component pairs across the RI layers of the precoding matrix in an increasing or decreasing order. In certain embodiments, the S bit fields with indices s={0, . . . , S−1}, are ordered in an increasing order from left to right.

The ordering of the bits associated with the s-th component pair in the s-th bit field is based on any one of the following ordering schemes.

In this embodiment, it is assumed that each combining coefficient associated with an s-th component pair (across the RI layers) of the precoding matrix is associated with the two indices (q,r), wherein q=0, . . . , Q−1, and r=0, . . . , RI−1, and the ordering of the indices u, u=0, . . . , Q·RI−1 associated with the bits of the s-th bit field and the indices of the combining coefficients follows one of the following schemes. Examples for the mapping from indices (q,r) to index u are explained in the following.

In one scheme, the ordering of the bits of the s-th bit field associated with the s-th component pair (across the RI layers) is given by u=Qr+q, where r={0, . . . , RI−1} and q={0, . . . , Q−1}. In another scheme, the ordering of the bits of the s-th bit field associated with the s-th component pair (across the RI layers) is given by u=RI·q+r, where r={0, . . . , RI−1} and q={0, . . . , Q−1}.

In a first example, the mapping between the associated SD and FD component to the s-th SD-FD component pair per layer is given by s=2Lm+l, where m∈{0, . . . , M−1} is the FD component index and l∈{0, . . . , 2L−1} is the SD component index. In a second example, the mapping between the associated SD and FD component to the s-th SD-FD component pair per layer is given by s=Ml+m, where m∈{0, . . . , M−1} is the FD component index and l∈{0, . . . , 2L−1} is the SD component index.

### Option 7:

In certain embodiments, the wireless device generates a bitmap comprising S bit fields, wherein S≤MQ, and the s-th bit field comprises 2L·RI bits. The S bit fields are associated with S FD-TD components the S bit fields with indices s={0, . . . , S−1}, are ordered in an increasing order from left to right. The mapping between the associated FD and TD component to the s-th FD-TD component pair per layer is given by s=Mq+m, where q∈{0, . . . , Q−1} is the TD component index and m∈{0, . . . , M−1} is the FD component index. The S FD-TD component pairs associated with S bit fields are grouped into Q groups, where the q-th group comprises M FD-TD component pairs associated with the same TD component. Moreover, the S bit fields are grouped into Q bit fields, wherein the q-th bit field comprises 2LM·RI bits. In one example, the Q groups are ordered with respect to an increasing TD component index. In another example, the Q groups are ordered with respect to a permutation function of the Q TD component indices. The ordering of the bits in each q-th group is given by of the following ordering schemes.

In this embodiment, it is assumed that each bit of a q-th group or bit field is associated with the three indices (l,r,m), wherein l=0, . . . , 2L−1, r=0, . . . , RI−1, m=0, . . . , M−1, and the ordering of the indices u, u=0, . . . , 2L M·RI−1 associated with the bits of the q-th bit field and the indices of the combining coefficients follows one of the following schemes. Examples for the mapping from indices (l,r,m) to index u are explained in the following.

In a first scheme, the ordering of the bits in each q-th group is given by u=2LMr+Ml+m, where r={0, . . . , RI}, m={0, . . . , M−1}, and l={0, . . . , 2L−1}. In a second scheme, the ordering of the bits in each q-th group is given by u=2LMr+2Lm+l, where r={0, . . . , RI}, m={0, . . . , M−1}, and l={0, . . . , 2L−1}. In a third scheme, the ordering of the bits in each q-th group is given by u=2L·RI·m+RI·l+r, where r={0, . . . , RI}, m={0, . . . , M−1}, and l={0, . . . , 2L−1}. In a fourth scheme, the ordering of the bits in each q-th group is given by u=2L·RI·m+2Lr+l, where r={0, . . . , RI}, m={0, . . . , M−1}, and l={0, . . . , 2L−1}. In a fifth scheme, the ordering of the bits in each q-th group is given by u=M·RI·l+Mr+m, where r={0, . . . , RI}, m={0, . . . , M−1}, and l={0, . . . , 2L−1}. In a sixth scheme, the ordering of the bits in each q-th group is given by u=M·RI·l+RI·m+r, where r={0, . . . , RI}, m={0, . . . , M−1}, and l={0, . . . , 2L−1}.

### Option 8:

In certain embodiments, the wireless device generates a bitmap comprising S bit fields, wherein S≤2LQ, and the s-th bit field comprises M·RI bits. The S bit fields are associated with S SD-TD components the S bit fields with indices s={0, . . . , S−1}, are ordered in an increasing order from left to right. The mapping between the associated SD and TD component to the s-th SD-TD component pair per layer is given by=2Lq+l, where q∈{0, . . . , Q−1} is the TD component index and l∈{0, . . . , 2L−1} is the SD component index.

The S SD-TD component pairs associated with S bit fields are grouped into Q groups, where the q-th group comprises 2L SD-TD component pairs associated with the same TD component. Moreover, the S bit fields are grouped into Q bit fields, wherein the q-th bit field comprises 2LM·RI bits. In one example, the Q groups are ordered with respect to an increasing TD component index. In another example, the Q groups are ordered with respect to a permutation function of the Q TD component indices. The ordering of the bits in each q-th group is given by of the following ordering schemes.

In this embodiment, it is assumed that each bit of a q-th group is associated with the three indices (m,r,l), wherein l=0, . . . , 2L−1, r=0, . . . , RI−1, m=0, . . . , M−1, and the ordering of the indices u, u=0, . . . , 2L·M·RI−1 associated with the bits of the m-th bit field and the indices of the combining coefficients follows one of the following schemes. Examples for the mapping from indices (m,r,l) to index u are explained in the following.

In a first scheme, the ordering of the bits in each q-th group is given by u=2LMr+Ml+m, where r={0, . . . , RI}, m={0, . . . , M−1}, and l={0, . . . , 2L−1}. In a second scheme, the ordering of the bits in each q-th group is given by u=2LMr+2Lm+l, where r={0, . . . , RI}, m={0, . . . , M−1}, and l={0, . . . , 2L−1}. In a third scheme, the ordering of the bits in each q-th group is given by u=2L·RI·m+RI+r, where r={0, . . . , RI}, m={0, . . . , M−1}, and l={0, . . . , 2L−1}. In a fourth scheme, the ordering of the bits in each q-th group is given by u=2L·RI·m+2Lr+l, where r={0, . . . , RI}, m={0, . . . , M−1}, and l={0, . . . , 2L−1}. In a fifth scheme, the ordering of the bits in each q-th group is given by u=M·RI·1+Mr+m, where r={0, . . . , RI}, m={0, . . . , M−1}, and l={0, . . . , 2L−1}. In a sixth scheme, the ordering of the bits in each q-th group is given by u=M·RI·l+RI·m+r, where r={0, . . . , RI}, m={0, . . . , M−1}, and l={0, . . . , 2L−1}.

### Option 9:

In certain embodiments, the wireless device generates a bitmap comprising S bit fields, wherein S≤MQ, and the s-th bit field comprises 2L·RI bits. The S bit fields are associated with S FD-TD components the S bit fields with indices s={0, . . . , S−1}, are ordered in an increasing order from left to right. The mapping between the associated FD and TD component to the s-th FD-TD component pair per layer is given by s=Qm+q, where q∈{0, . . . , Q−1} is the TD component index and m∈{0, . . . , M−1} is the FD component index. The S FD-TD component pairs associated with S bit fields are grouped into M groups, where the m-th group comprises Q FD-TD component pairs associated with the same FD component. Moreover, the S bit fields are grouped into M bit fields, wherein the m-th bit field comprises 2LQ·RI bits. In one example, the M groups are ordered with respect to an increasing FD component index. In another example, the M groups are ordered with respect to a permutation function of the M FD component indices. The ordering of the bits in each m-th group is given by of the following ordering schemes.

In this embodiment, it is assumed that each bit of a m-th group is associated with the three indices (l,r,q), wherein l=0, . . . , 2L−1, r=0, . . . , RI−1, q=0, . . . , Q−1, and the ordering of the indices u, u=0, . . . , 2L Q·RI−1 associated with the bits of the m-th bit field and the indices of the combining coefficients follows one of the following schemes. Examples for the mapping from indices (l,r,q) to index u are explained in the following.

In a first scheme, the ordering of the bits in each m-th group is given by u=2LQr+Ql+q, where r={0, . . . , RI}, q={0, . . . , Q−1}, and l={0, . . . , 2L−1}. In a second scheme, the ordering of the bits in each m-th group is given by u=2LQr+2Lq+l, where r={0, . . . , RI}, q={0, . . . , Q−1}, and l={0, . . . , 2L−1}. In a third scheme, the ordering of the bits in each m-th group is given by u=2L·RI·q+RI·l+r, where r={0, . . . , RI}, q={0, . . . , Q−1}, and l={0, . . . , 2L−1}. In a fourth scheme, the ordering of the bits in each m-th group is given by u=2L·RI·q+2Lr+l, where r={0, . . . , RI}, q={0, . . . , Q−1}, and l={0, . . . , 2L−1}. In a fifth scheme, the ordering of the bits in each m-th group is given by u=Q·RI·l+Qr+q, where r={0, . . . , RI}, q={0, . . . , Q−1}, and l={0, . . . , 2L−1}. In a sixth scheme, the ordering of the bits in each m-th group is given by u=Q·RI·l+RI·q+r, where r={0, . . . , RI}, q={0, . . . , Q−1}, and l={0, . . . , 2L−1}.

### Option 10:

In certain embodiments, the wireless device generates a bitmap comprising S bit fields, wherein S≤2LM, and the s-th bit field comprises Q·RI bits. The S bit fields are associated with S SD-FD components the S bit fields with indices s={0, . . . , S−1}, are ordered in an increasing order from left to right. The mapping between the associated SD and FD component to the s-th SD-FD component pair per layer is given by s=2Lm+l, where m∈{0, . . . , M−1} is the FD component index and l∈{0, . . . , 2L−1} is the SD component index.

The S SD-FD component pairs associated with S bit fields are grouped into M groups, where the m-th group comprises 2L SD-FD component pairs associated with the same FD component. Moreover, the S bit fields are grouped into M bit fields, wherein the m-th bit field comprises 2LQ·RI bits. In one example, the M groups are ordered with respect to an increasing FD component index. In another example, the M groups are ordered with respect to a permutation function of the M FD component indices. The ordering of the bits in each m-th group is given by of the following ordering schemes.

In this embodiment, it is assumed that each bit of a m-th group is associated with the three indices (q,r,l), wherein q=0, . . . , Q−1, r=0, . . . , RI−1, l=0, . . . , 2L−1, and the ordering of the indices u, u=0, . . . , 2LQ·RI−1 associated with the bits of the m-th bit field and the indices of the combining coefficients follows one of the following schemes. Examples for the mapping from indices (q,r,l) to index u are explained in the following.

In a first scheme, the ordering of the bits in each m-th group is given by u=2LQr+Ql+q, where r={0, . . . , RI}, q={0, . . . , Q−1}, and l={0, . . . , 2L−1}. In a second scheme, the ordering of the bits in each m-th group is given by u=2LQr+2Lq+l, where r={0, . . . , RI}, q={0, . . . , Q−1}, and l={0, . . . , 2L−1}. In a third scheme, the ordering of the bits in each m-th group is given by u=2L·RI·q+RI+r, where r={0, . . . , RI}, q={0, . . . , Q−1}, and l={0, . . . , 2L−1}. In a fourth scheme, the ordering of the bits in each m-th group is given by u=2L·RI·q+2Lr+l, where r={0, . . . , RI}, q={0, . . . , Q−1}, and l={0, . . . , 2L−1}. In a fifth scheme, the ordering of the bits in each m-th group is given by u=Q·RI·l+Qr+q, where r={0, . . . , RI}, q={0, . . . , Q−1}, and l={0, . . . , 2L−1}. In a sixth scheme, the ordering of the bits in each m-th group is given by u=Q·RI·l+RI·q+r, where r={0, . . . , RI}, q={0, . . . , Q−1}, and l={0, . . . , 2L−1}.

### Option 11:

In certain embodiments, the wireless device generates a bitmap comprising S bit fields, wherein S≤2LQ, and the s-th bit field comprises M·RI bits. The S bit fields are associated with S SD-TD components the S bit fields with indices s={0, . . . , S−1}, are ordered in an increasing order from left to right. The mapping between the associated SD and TD component to the s-th SD-TD component pair per layer is given by=Ql+q, where q∈{0, . . . , Q−1} is the TD component index and l∈{0, . . . , 2L−1} is the SD component index. The S SD-TD component pairs associated with S bit fields are grouped into 2L groups, where the 1-th group comprises Q SD-TD component pairs associated with the same SD component. Moreover, the S bit fields are grouped into 2L bit fields, wherein the 1-th bit field comprises MQ·RI bits. In one example, the 2L groups are ordered with respect to an increasing FD component index. In another example, the 2L groups are ordered with respect to a permutation function of the 2L SD component indices. The ordering of the bits in each l-th group is given by of the following ordering schemes.

In this embodiment, it is assumed that each bit of a l-th group is associated with the three indices (m,r,q), wherein q=0, . . . , Q−1, r=0, . . . , RI−1, m=0, . . . , M−1, and the ordering of the indices u, u=0, . . . , MQ·RI−1 associated with the bits of the l-th bit field and the indices of the combining coefficients follows one of the following schemes. Examples for the mapping from indices (m,r,q) to index u are explained in the following.

In a first scheme, the ordering of the bits in each l-th group is given by u=MQr+Qm+q, where r={0, . . . , RI}, q={0, . . . , Q−1}, and m={0, . . . , M−1}. In a second scheme, the ordering of the bits in each l-th group is given by u=MQr+Mq+m, where r={0, . . . , RI}, q={0, . . . , Q−1}, and m={0, . . . , M−1}. In a third scheme, the ordering of the bits in each l-th group is given by u=M·RI q+Rm+r, where r={0, . . . , RI}, q={0, . . . , Q−1}, and m={0, . . . , M−1}. In a fourth scheme, the ordering of the bits in each l-th group is given by u=M·RI·q+Mr+m, where r={0, . . . , RI}, q={0, . . . , Q−1}, and m={0, . . . , M−1}. In a fifth scheme, the ordering of the bits in each l-th group is given by u=Q·RI·m+Qr+q, where r={0, . . . , RI}, q={0, . . . , Q−1}, and m={0, . . . , M−1}. In a sixth scheme, the ordering of the bits in each l-th group is given by u=Q·RI·m+RI·q+r, where r={0, . . . , RI}, q={0, . . . , Q−1}, and m={0, . . . , M−1}.

### Option 12:

In certain embodiments, the wireless device generates a bitmap comprising S bit fields, wherein S≤2LM, and the s-th bit field comprises Q·RI bits. The S bit fields are associated with S SD-FD components the S bit fields with indices s={0, . . . , S−1}, are ordered in an increasing order from left to right. The mapping between the associated SD and FD component to the s-th SD-FD component pair per layer is given by s=Ml+m, where m∈{0, . . . , M−1} is the FD component index and l∈{0, . . . , 2L−1} is the SD component index. The S SD-FD component pairs associated with S bit fields are grouped into 2L groups, where the l-th group comprises M SD-FD component pairs associated with the same SD component. Moreover, the S bit fields are grouped into 2L bit fields, wherein the l-th bit field comprises MQ·RI bits. In one example, the 2L groups are ordered with respect to an increasing SD component index. In another example, the 2L groups are ordered with respect to a permutation function of the 2L SD component indices. The ordering of the bits in each l-th group is given by of the following ordering schemes.

In this embodiment, it is assumed that each bit of a l-th group is associated with the three indices (q,r,m), wherein q=0, . . . , Q−1, r=0, . . . , RI−1, m=0, . . . , M−1, and the ordering of the indices u, u=0, . . . , MQ·RI−1 associated with the bits of the l-th bit field and the indices of the combining coefficients follows one of the following schemes. Examples for the mapping from indices (q,r,m) to index u are explained in the following.

In a first scheme, the ordering of the bits in each l-th group is given by u=MQr+Qm+q, where r={0, . . . , RI}, q={0, . . . , Q−1}, and m={0, . . . , M−1}. In a second example, the ordering of the bits in each l-th group is given by u=MQr+Mq+m, where r={0, . . . , RI}, q={0, . . . , Q−1}, and m={0, . . . , M−1}. In a third example, the ordering of the bits in each l-th group is given by u=M·RI q+Rm+r, where r={0, . . . , RI}, q={0, . . . , Q−1}, and m={0, . . . , M−1}. In a fourth example, the ordering of the bits in each m-th group is given by u=M·RI·q+Mr+m, where r={0, . . . , RI}, q={0, . . . , Q−1}, and m={0, . . . , M−1}. In a fifth example, the ordering of the bits in each l-th group is given by u=Q·RI·m+Qr+q, where r={0, . . . , RI}, q={0, . . . , Q−1}, and m={0, . . . , M−1}. In a sixth example, the ordering of the bits in each m-th group is given by u=Q·RI·m+RI·q+r, where r={0, . . . , RI}, q={0, . . . , Q−1}, and m={0, . . . , M−1}.

### Reporting and Configuration of Number of Non-Zero Combining Coefficients

In certain embodiments, the wireless device is configured to determine K or less than K non-zero combining coefficients per layer out of 2LS combining coefficients, wherein S≤MQ. In certain embodiments, the wireless device is configured to determine K or less than K non-zero combining coefficients across all RI layers out of 2LS. RI combining coefficients, wherein S≤MQ.

In certain embodiments, the wireless device is configured to determine K or less than K non-zero combining coefficients per layer out of MS combining coefficients, wherein S≤2LQ. In certain embodiments, the wireless device is configured to determine K or less than K non-zero combining coefficients across all RI layers out of MS. RI combining coefficients, wherein S≤2LQ.

In certain embodiments, the wireless device is configured to determine K or less than K non-zero combining coefficients per layer out of the 2LS combining coefficients, wherein S≤2LM. In certain embodiments, the wireless device is configured to determine K or less than K non-zero combining coefficients across all RI layers out of the 2LS. RI combining coefficients, wherein S≤2LM.

In certain embodiments, the maximum number of non-zero combining coefficients K is a function of three parameters, L, M and #, where L is the number of configured SD components, M is the number of configured FD components M, and #3 is a parameter configured by the network to control the number of non-zero coefficients.

In certain embodiments, the maximum number of non-zero combining coefficients K is a function of three parameters, L, M and Q, where L is the number of configured SD components, M is the number of configured FD components, and Q is the number of configured TD components.

In certain embodiments, the maximum number of non-zero combining coefficients do not exceed 2LS per layer, where S<MQ and L is the number of configured SD components, M is the number of configured FD components, Q is the number of configured TD components, and S is the number of FD-TD component pairs per layer.

In certain embodiments, the maximum number of non-zero combining coefficients do not exceed MS per layer, where S<2LQ, and L is the number of configured SD components, M is the number of configured FD components, Q is the number of configured TD components, and S is the number of SD-TD component pairs per layer.

In certain embodiments, the maximum number of non-zero combining coefficients do not exceed QS per layer, where S<2LM, and L is the number of configured SD components, M is the number of configured FD components, Q is the number of configured TD components, and S is the number of SD-FD component pairs per layer.

### Partitioning of Bits in Bitmap in CSI Report

In certain embodiments, the bits of the bitmap are segmented into two segments, wherein the first segment comprises the first

$$RI - ⌊ \frac{K}{2} ⌋ bits$$

bits and assigned to CSI group 1 and the second segment comprises the remaining

$$⌊ \frac{K}{2} ⌋ bits$$

and assigned to CSI group 2, and wherein S<MQ.

In certain embodiments, the bits of the bitmap are segmented into two segments, wherein the first segment comprises the first MS.

$$RI - ⌊ \frac{K}{2} ⌋ bits$$

and assigned to CSI group 1 and the second segment comprises the remaining

$$⌊ \frac{K}{2} ⌋ bits$$

and assigned to CSI group 2, and wherein S≤2LQ.

In certain embodiments, the bits of the bitmap are segmented into two segments, wherein the first segment comprises the first QS.

$$RI - ⌊ \frac{K}{2} ⌋ bits$$

and assigned to CSI group 1 and the second segment comprises the remaining

$$⌊ \frac{K}{2} ⌋ bits$$

bits and assigned to CSI group 2, and wherein S≤2LM.

### Partitioning of Number of Non-Zero Coefficients in CSI Report

In certain embodiments, the amplitude values or the differential amplitude values (e.g, in case that each amplitude coefficient of a non-zero coefficient is represented by product of a reference or common amplitude coefficient and a differential amplitude coefficient) of the K or less than K non-zero combining coefficients in the CSI report are quantized with A bits common amplitude and B bits of differential amplitude.

In certain embodiments, the total number of bits associated with the phase and amplitude (or differential amplitude values) of the K or less than K non-zero combining coefficients are segmented into two segments, wherein the first segment is assigned to CSI group 1, and the second segment is assigned to CSI group 2.

In certain embodiments, the phase values of K or less than K non-zero combining coefficient in the CSI report are quantized with using C bits, respectively.

In certain embodiments, the total number of bits used for quantizing the differential amplitude of the K or less than K non-zero combining coefficients is segmented into two or more segments and assigned to two or more CSI groups.

In certain embodiments, the total number of bits associated with the differential amplitude of the K or less than K non-zero combining coefficients is segmented into two segments, wherein the first segment comprises a maximum of

$$( ⌈ \frac{K}{2} ⌉ - RI ) \cdot B bits$$

and is assigned to CSI group 1, and the second segment comprises a maximum of

$$⌊ \frac{K}{2} ⌋ \cdot B bits$$

and is assigned to CSI group 2. In certain embodiments, the total number of bits associated with the phase of the K or less than K non-zero combining coefficients is segmented into two segments, wherein the first segment comprises a maximum of

$$( ⌈ \frac{K}{2} ⌉ - RI ) \cdot C bits$$

and is assigned to CSI group 1, and the second segment comprises a maximum of

$$⌊ \frac{K}{2} ⌋ \cdot C bits$$

and is assigned to CSI group 2.

In certain embodiments, the total number of bits associated with the differential amplitude of the K or less than K non-zero combining coefficients is segmented into two segments, wherein the first segment comprises a maximum of max

$$( 0 , ( ⌈ \frac{K}{2} ⌉ - RI ) ) \cdot B bits$$

and is assigned to CSI group 1, and the second segment comprises a maximum of min

$$( K - RI , ⌊ \frac{K}{2} ⌋ ) \cdot B bits$$

and is assigned to CSI group 2.

In certain embodiments, the total number of bits associated with the phase of the K or less than K non-zero combining coefficients is segmented into two segments, wherein the first segment comprises a maximum of max

$$( 0 , ( ⌈ \frac{K}{2} ⌉ - RI ) ) \cdot C bits$$

and is assigned to CSI group 1, and the second segment comprises a maximum of min

$$( K - RI , ⌊ \frac{K}{2} ⌋ ) \cdot C bits$$

and is assigned to CSI group 2.

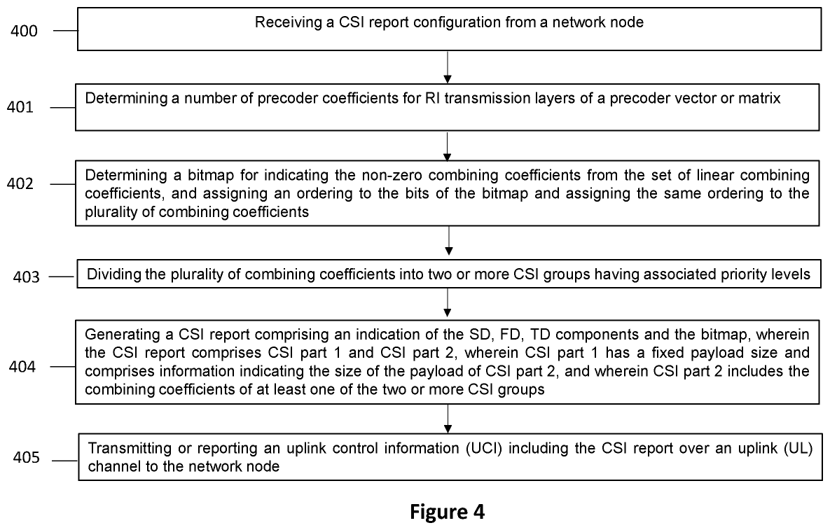

Referring to FIG. 4, there is illustrated a method performed by a wireless device according to some of the previously described embodiments. The method is performed by the wireless device (or UE) for generating and transmitting a CSI report in a wireless communication system, the CSI report indicating a plurality of precoder vectors or matrices, a precoder vector or matrix being expressed as a linear combination of spatial-domain component(s), frequency-domain component(s) and time-domain component(s), and a set of linear combination coefficients for combining the spatial-, frequency- and time-domain components. As shown, the method comprising:
receiving (400) a CSI report configuration from a network node;
determining (401) based on the received CSI report configuration information a number of precoder coefficients for RI transmission layers of a precoder vector or matrix;
determining (402) a bitmap for indicating the non-zero combining coefficients from the set of linear combining coefficients, and assigning an ordering to the bits of the bitmap and assigning the same ordering to the plurality of combining coefficients,
dividing (403) the plurality of combining coefficients into two or more CSI groups having associated priority levels;
generating (404) a CSI report comprising an indication of the SD, FD, TD components and the bitmap, wherein the CSI report comprises CSI part 1 and CSI part 2, wherein CSI part 1 has a fixed payload size and comprises information indicating the size of the payload of CSI part 2, and wherein CSI part 2 includes the combining coefficients of at least one of the two or more CSI groups;
transmitting (405) or reporting an uplink control information (UCI) including the CSI report over an uplink (UL) channel to the network node.

In certain embodiments, wherein one or more spatial domain, SD, components, one or more frequency domain, FD, components, one or more time domain, TD, components for the set of linear combination coefficients are determined by the wireless device for the precoding vector or matrix, and wherein the SD, FD, and TD component(s) are indicated in the CSI report.

In certain embodiments, wherein a number, S, FD-TD, or SD-TD, or SD-FD component pairs are determined and indicated in the CSI report.

In certain embodiments, wherein the value of S is indicated in CSI part 1 or CSI part 2 of the CSI report.

In certain embodiments, wherein the CSI report comprises multiple CSI groups for UCI or CSI omission, and the bitmap comprises RI bit fields, wherein the r-th bit field is associated with an r-th layer index and comprises 2LS bits and the ordering of the bits within each bit field is a function of the SD component index (l) and FD-TD component pair index (s), given by u=2Ls+l, or u=Sl+s, wherein l={0, . . . , 2L−1}, and s={0, . . . , S−1}.

In certain embodiments, wherein the CSI report comprises multiple CSI groups for UCI or CSI omission, and the bitmap comprises S bit fields, wherein the s-th bit field is associated with an s-th FD-TD component pair index and comprises 2L·RI bits and the ordering of the bits within each bit field is a function of the SD component index (l) and layer index (r), given by u=2Lr+l, or u=RI·l+r, wherein l={0, . . . , 2L−1}, and r={0, . . . , RI−1}.

In certain embodiments, wherein the mapping between the associated FD component and TD component to the s-th FD-TD component pair per layer is given by s=Qm+q or s=Mq+m, where q∈{0, . . . , Q−1} is a TD component index and m∈{0, . . . , M−1} is a FD component index.

In certain embodiments, wherein a bitmap is determined and used to indicate the non-zero combining coefficients from the set of linear combining coefficients in the CSI report.

In certain embodiments, the CSI report comprises multiple CSI groups for UCI or CSI omission.

In certain embodiments, the bitmap is assigned to the CSI group with highest priority, or to two or more CSI groups of the CSI report.

In certain embodiments, the number of SD components of the precoding matrix, L, is configured to the wireless device. In certain embodiments, the number of TD components of the precoding matrix, Q, is configured to the wireless device. In certain embodiments, the number of FD components of the precoding matrix, M, is configured to the wireless device.

In certain embodiments, the phase and amplitude (or differential amplitude values) of the non-zero combining coefficients in the CSI report are segmented into two segments, wherein the first segment is assigned to CSI group 1, and the second segment is assigned to CSI group 2 of the CSI report.

In certain embodiments, the bits in the bitmap are segmented into two segments in the CSI report, wherein the first segment is assigned to CSI group 1, and the second segment is assigned to CSI group 2 of the CSI report.

### Ordering of Bits in Bitmap and Combining Coefficients

### Option 1:

In certain embodiments, the bitmap comprises RI bit fields, wherein the r-th bit field is associated with an r-th layer index and comprises 2LS bits and each bit of the r-th bit field is associated with one SD component index (l) out of the 2L SD component indices and with one FD-TD component pair index (s) out of the S FD-TD component pair indices. In certain embodiments, the ordering of the bits within each bit field is a function of the SD component index and FD-TD component pair index, given by u=2Ls+l, or u=Sl+s, wherein l={0, . . . , 2L−1}, s={0, . . . , S−1}. In certain embodiments, the mapping between the associated FD component and TD component to the s-th FD-TD component pair per layer is given by s=Qm+q or s=Mq+m, where q∈{0, . . . , Q−1} is the TD component index and m∈{0, . . . , M−1} is the FD component index. In certain embodiments, the RI bit fields with indices r={0, . . . , RI−1}, are ordered in an increasing order from left to right.

### Option 2:

In certain embodiments, the bitmap comprises RI bit fields, wherein the r-th bit field is associated with an r-th layer index and comprises MS bits and each bit of the r-th bit field is associated with one FD component index (m) out of the M FD component indices and with one SD-TD component pair index (s) out of the S SD-TD component pair indices. In certain embodiments, the ordering of the bits within each bit field is a function of the FD component index and SD-TD component pair index, given by u=Ms+m, or u=Sm+s, wherein m={0, . . . , M−1}, s={0, . . . , S−1}. In certain embodiments, the mapping between the associated SD component and TD component to the s-th SD-TD component pair per layer is given by s=2Lq+l or s=Ql+q, where q∈{0, . . . , Q−1} is the TD component index and l∈{0, . . . , 2L−1} is the SD component index. In certain embodiments, the RI bit fields with indices r={0, . . . , RI−1}, are ordered in an increasing order from left to right.

### Option 3:

In certain embodiments, the bitmap comprises RI bit fields, wherein the r-th bit field is associated with an r-th layer index and comprises QS bits and each bit of the r-th bit field is associated with one TD component index (q) out of the Q FD component indices and with one SD-FD component pair index (s) out of the S SD-FD component pair indices. In certain embodiments, the ordering of the bits within each bit field is a function of the TD component index and SD-FD component pair index, given by u=Qs+q, or u=Sq+s, wherein q={0, . . . , Q−1}, s={0, . . . , S−1}. In certain embodiments, the mapping between the associated SD component and FD component to the s-th SD-FD component pair per layer is given by s=2Lm+l or s=Ml+m, where m∈{0, . . . , M−1} is the FD component index and l∈{0, . . . , 2L−1} is the SD component index. In certain embodiments, the RI bit fields with indices r={0, . . . , RI−1}, are ordered in an increasing order from left to right.

### Option 4:

In certain embodiments, the bitmap comprises S bit fields, wherein the s-th bit field is associated with an s-th FD-TD component pair index and comprises 2L·RI bits and each bit of the s-th bit field is associated with one SD component index (l) out of the 2L SD component indices and with one layer index (r) out of RI layers. In certain embodiments, the ordering of the bits within each bit field is a function of the SD component index and layer index, given by u=2Lr+l, or u=RI·l+r, wherein r=0, . . . , RI−1 and l=0, . . . , 2L−1. In certain embodiments, the mapping between the associated FD component and TD component to the s-th FD-FD component pair per layer is given by s=Qm+q, or s=Mq+m, where m∈{0, . . . , M−1} is the FD component index and q∈{0, . . . , Q−1} is the TD component index. In certain embodiments, the S bit fields with indices s={0, . . . , S−1}, are ordered in an increasing order from left to right.

### Option 5:

In certain embodiments, the bitmap comprises S bit fields, wherein the s-th bit field is associated with an s-th SD-TD component pair index and comprises M·RI bits and each bit of the s-th bit field is associated with one FD component index (m) out of the M FD component indices and with one layer index (r) out of RI layers. In certain embodiments, the ordering of the bits within each bit field is a function of the FD component index and layer index, given by u=Mr+m, or u=RI·m+r, wherein r=0, . . . , RI−1 and m=0, . . . , M−1. In certain embodiments, the mapping between the associated SD component and TD component to the s-th SD-TD component pair per layer is given by s=2Lq+l, or s=Ql+q, where l∈{0, . . . , 2L−1} is the SD component index and q∈{0, . . . , Q−1} is the TD component index. In certain embodiments, the S bit fields with indices s={0, . . . , S−1}, are ordered in an increasing order from left to right.

### Option 6:

In certain embodiments, the bitmap comprises S bit fields, wherein the s-th bit field is associated with an s-th SD-FD component pair index and comprises Q·RI bits and each bit of the s-th bit field is associated with one TD component index (q) out of the Q FD component indices and with one layer index (r) out of RI layers. In certain embodiments, the ordering of the bits within each bit field is a function of the TD component index and layer index, given by u=Qr+q, or u=RI·q+r, wherein r=0, . . . , RI−1 and q=0, . . . , Q−1. In certain embodiments, the mapping between the associated SD component and FD component to the s-th SD-FD component pair per layer is given by s=2Lm+l, or s=Ml+m, where l∈{0, . . . , 2L−1} is the SD component index and m∈{0, . . . , M−1} is the FD component index. In certain embodiments, the S bit fields with indices s={0, . . . , S−1}, are ordered in an increasing order from left to right.

### Option 7:

In certain embodiments, the bitmap comprises S bit fields, wherein S≤MQ and the s-th bit field is associated with an s-th FD-TD component pair index and comprises 2L·RI bits and each bit of the s-th bit field is associated with one SD component index (l) out of the 2L SD component indices and with one layer index (r) out of RI layers. In certain embodiments, the S bit fields with indices s={0, . . . , S−1}, are ordered in an increasing order from left to right.

In certain embodiments, the mapping between the associated FD and TD component to the s-th FD-TD component pair per layer is given by s=Mq+m, where q∈{0, . . . , Q−1} is the TD component index and m∈{0, . . . , M−1} is the FD component index.

In certain embodiments, for S=MQ, the S FD-TD component pairs associated with S bit fields are grouped into Q groups, where the q-th group comprises M FD-TD component pairs associated with the same TD component.

In certain embodiments, for S<MQ, the S FD-TD component pairs associated with S bit fields are grouped into Q′ groups, wherein the q-th group comprises M or M′ FD-TD component pairs associated with the same TD component, wherein Q′<Q and M′<M.

In certain embodiments, for S<MQ, the S FD-TD component pairs associated with S bit fields are grouped into Q groups, wherein the q-th group comprises M or M′ FD-TD component pairs associated with the same TD component, wherein Q′<Q and M′<M.

### Option 8:

In certain embodiments, the bitmap comprises S bit fields, wherein S≤2LQ and the s-th bit field is associated with an s-th SD-TD component pair index and comprises M·RI bits and each bit of the s-th bit field is associated with one FD component index (m) out of the M FD component indices and with one layer index (r) out of RI layers. In certain embodiments, the S bit fields with indices s={0, . . . , S−1}, are ordered in an increasing order from left to right.

In certain embodiments, the mapping between the associated SD and TD component to the s-th SD-TD component pair per layer is given by s=2Lq+l, where q∈{0, . . . , Q−1} is the TD component index and l∈{0, . . . , 2L−1} is the SD component index.

In certain embodiments, for S=2LQ, the S SD-TD component pairs associated with S bit fields are grouped into Q groups, where the q-th group comprises 2L SD-TD component pairs associated with the same TD component.

In certain embodiments, for S<2LQ, the S SD-TD component pairs associated with S bit fields are grouped into Q′ groups, wherein the q-th group comprises 2L or 2L′ SD-TD component pairs associated with the same TD component, wherein Q′<Q and L′<L.

In certain embodiments, for S<2LQ, the S SD-TD component pairs associated with S bit fields are grouped into Q groups, wherein the q-th group comprises 2L or 2L′ SD-TD component pairs associated with the same TD component, wherein Q′<Q and L′<L.

In certain embodiments, the S bit fields are grouped into Q or Q′ bit fields, wherein the q-th bit field comprises 2LM·RI bits. In certain embodiments, the Q or Q′ groups or bit fields are ordered with respect to an increasing TD component index. In certain embodiments, the Q or Q′ groups are ordered with respect to a permutation function of the Q TD component indices.

### Ordering Schemes for Option 7 and Option 8:

In certain embodiments, the ordering of the bits within each q-th bit field is a function of the SD component index (l), FD component index (m) and layer index (r), and is given by u=2LMr+Ml+m, where r={0, . . . , RI}, m={0, . . . , M−1}, and l={0, . . . , 2L−1}.

In certain embodiments, the ordering of the bits within each q-th bit field is a function of the SD component index (l), FD component index (m) and layer index (r), and is given by u=2LMr+2Lm+l, where r={0, . . . , RI}, m={0, . . . , M−1}, and l={0, . . . , 2L−1}.

In certain embodiments, the ordering of the bits within each q-th bit field is a function of the SD component index (l), FD component index (m) and layer index (r), and is given by u=2L·RI·m+RI·l+r, where r={0, . . . , RI}, m={0, . . . , M−1}, and l={0, . . . , 2L−1}.

In certain embodiments, the ordering of the bits within each q-th bit field is a function of the SD component index (l), FD component index (m) and layer index (r), and is given by u=2L·RI·m+2Lr+l, where r={0, . . . , RI}, m={0, . . . , M−1}, and l={0, . . . , 2L−1}.

In certain embodiments, the ordering of the bits within each q-th bit field is a function of the SD component index (l), FD component index (m) and layer index (r), and is given by u=M·RI·l+Mr+m, where r={0, . . . , RI}, m={0, . . . , M−1}, and l={0, . . . , 2L−1}.

In certain embodiments, the ordering of the bits within each q-th bit field is a function of the SD component index (l), FD component index (m) and layer index (r), and is given by u=M·RI·l+RI·m+r, where r={0, . . . , RI}, m={0, . . . , M−1}, and l={0, . . . , 2L−1}.

### Option 9:

In certain embodiments, the bitmap comprises S bit fields, wherein S≤MQ and the s-th bit field is associated with an s-th FD-TD component pair index and comprises 2L·RI bits and each bit of the s-th bit field is associated with one SD component index (l) out of the 2L SD component indices and with one layer index (r) out of RI layers. In certain embodiments, the S bit fields with indices s={0, . . . , S−1}, are ordered in an increasing order from left to right.

In certain embodiments, the mapping between the associated FD and TD component to the s-th FD-TD component pair per layer is given by s=Qm+q, where q∈{0, . . . , Q−1} is the TD component index and m∈{0, . . . , M−1} is the FD component index.

In certain embodiments, for S=MQ, the S FD-TD component pairs associated with S bit fields are grouped into M groups, where the m-th group comprises Q FD-TD component pairs associated with the same FD component.

In certain embodiments, for S<MQ, the S FD-TD component pairs associated with S bit fields are grouped into M′ groups, wherein the m-th group comprises Q or Q′ FD-TD component pairs associated with the same FD component, wherein Q′<Q and M′<M.

In certain embodiments, for S<MQ, the S FD-TD component pairs associated with S bit fields are grouped into M groups, wherein the m-th group comprises Q or Q′ FD-TD component pairs associated with the same FD component, wherein Q′<Q and M′<M.

In certain embodiments, the S bit fields are grouped into M or M′ bit fields, wherein the m-th bit field comprises 2LQ·RI bits. In certain embodiments, the M or M′ groups or bit fields are ordered with respect to an increasing FD component index. In certain embodiments, the M or M′ groups are ordered with respect to a permutation function of the M FD component indices.

### Option 10:

In certain embodiments, the bitmap comprises S bit fields, wherein S≤2LM and the s-th bit field is associated with an s-th SD-FD component pair index and comprises Q·RI bits and each bit of the s-th bit field is associated with one TD component index (q) out of the Q TD component indices and with one layer index (r) out of RI layers. In certain embodiments, the S bit fields with indices s={0, . . . , S−1}, are ordered in an increasing order from left to right.

In certain embodiments, the mapping between the associated SD and FD component to the s-th SD-FD component pair per layer is given by s=2Lm+l, where l∈{0, . . . , 2L−1} is the SD component index and m∈{0, . . . , M−1} is the FD component index.

In certain embodiments, for S=2LM, the S SD-FD component pairs associated with S bit fields are grouped into M groups, where the m-th group comprises 2L SD-FD component pairs associated with the same FD component.

In certain embodiments, for S<2LM, the S SD-FD component pairs associated with S bit fields are grouped into M′ groups, wherein the m-th group comprises 2L or 2L′ SD-FD component pairs associated with the same FD component, wherein L′<L and M′<M.

In certain embodiments, for S<2LM, the S SD-FD component pairs associated with S bit fields are grouped into M groups, wherein the m-th group comprises 2L or 2L′ SD-FD component pairs associated with the same FD component, wherein L′<L and M′<M.

In certain embodiments, the S bit fields are grouped into M or M′ bit fields, wherein the m-th bit field comprises 2LQ·RI bits. In certain embodiments, the M or M′ groups or bit fields are ordered with respect to an increasing FD component index. In certain embodiments, the M or M′ groups are ordered with respect to a permutation function of the M FD component indices.

### Ordering Schemes for Option 9 and Option 10:

In certain embodiments, the ordering of the bits within each m-th bit field is a function of the SD component index (l), TD component index (q) and layer index (r), and is given by u=2LQr+Ql+q, where r={0, . . . , RI}, q={0, . . . , Q−1}, and l={0, . . . , 2L−1}.

In certain embodiments, the ordering of the bits within each m-th bit field is a function of the SD component index (l), TD component index (q) and layer index (r), and is given by u=2LQr+2Lq+l, where r={0, . . . , RI}, q={0, . . . , Q−1}, and l={0, . . . , 2L−1}.

In certain embodiments, the ordering of the bits within each m-th bit field is a function of the SD component index (l), TD component index (q) and layer index (r), and is given by u=2L·RI·q+RI·l+r, where r={0, . . . , RI}, q={0, . . . , Q−1}, and l={0, . . . , 2L−1}.

In certain embodiments, the ordering of the bits within each m-th bit field is a function of the SD component index (l), TD component index (q) and layer index (r), and is given by u=2L·RI·q+2Lr+l, where r={0, . . . , RI}, q={0, . . . , Q−1}, and l={0, . . . , 2L−1}.

In certain embodiments, the ordering of the bits within each m-th bit field is a function of the SD component index (l), TD component index (q) and layer index (r), and is given by u=Q·RI·l+Qr+q, where r={0, . . . , RI}, q={0, . . . , Q−1}, and l={0, . . . , 2L−1}.

In certain embodiments, the ordering of the bits within each m-th bit field is a function of the SD component index (l), TD component index (q) and layer index (r), and is given by u=Q·RI·l+RI·q+r, where r={0, . . . , RI}, q={0, . . . , Q−1}, and l={0, . . . , 2L−1}.

### Option 11:

In certain embodiments, the bitmap comprises S bit fields, wherein S≤2LQ and the s-th bit field is associated with an s-th SD-TD component pair index and comprises M·RI bits and each bit of the s-th bit field is associated with one FD component index (m) out of the M FD component indices and with one layer index (r) out of RI layers. In certain embodiments, the S bit fields with indices s={0, . . . , S−1}, are ordered in an increasing order from left to right.

In certain embodiments, the mapping between the associated SD and TD component to the s-th SD-TD component pair per layer is given by s=Ql+q, q∈{0, . . . , Q−1} is the TD component index and l∈{0, . . . , 2L−1} is the SD component index.

In certain embodiments, for S=2LQ, the S SD-TD component pairs associated with S bit fields are grouped into 2L groups, where the l-th group comprises Q SD-TD component pairs associated with the same SD component.

In certain embodiments, for S<2LQ, the S SD-TD component pairs associated with S bit fields are grouped into 2L′ groups, wherein the l-th group comprises Q or Q′ SD-TD component pairs associated with the same SD component, wherein L′<L and Q′<Q.

In certain embodiments, for S<2LQ, the S SD-TD component pairs associated with S bit fields are grouped into 2L groups, wherein the l-th group comprises Q or Q′ SD-TD component pairs associated with the same SD component, wherein L′<L and Q′<Q.

In certain embodiments, the S bit fields are grouped into 2L or 2L′ bit fields, wherein the l-th bit field comprises MQ·RI bits. In certain embodiments, the 2L or 2L′ groups or bit fields are ordered with respect to an increasing SD component index. In certain embodiments, the 2L or 2L′ groups are ordered with respect to a permutation function of L or 2L SD component indices.

### Option 12:

In certain embodiments, the bitmap comprises S bit fields, wherein S≤2LM and the s-th bit field is associated with an s-th SD-FD component pair index and comprises Q·RI bits and each bit of the s-th bit field is associated with one TD component index (q) out of the Q TD component indices and with one layer index (r) out of RI layers. In certain embodiments, the S bit fields with indices s={0, . . . , S−1}, are ordered in an increasing order from left to right.

In certain embodiments, the mapping between the associated SD and FD component to the s-th SD-FD component pair per layer is given by s=Ml+m, where l∈{0, . . . , 2L−1} is the SD component index and m∈{0, . . . , M−1} is the FD component index.

In certain embodiments, for S=2LM, the S SD-FD component pairs associated with S bit fields are grouped into 2L groups, where the l-th group comprises M SD-FD component pairs associated with the same SD component.

In certain embodiments, for S<2LM, the S SD-FD component pairs associated with S bit fields are grouped into 2L′ groups, wherein the l-th group comprises M or M′ SD-FD component pairs associated with the same SD component, wherein L′<L and M′<M.

In certain embodiments, for S<2LM, the S SD-FD component pairs associated with S bit fields are grouped into 2L groups, wherein the l-th group comprises M or M′ SD-FD component pairs associated with the same SD component, wherein L′<L and M′<M.

In certain embodiments, the S bit fields are grouped into 2L or 2L′ bit fields, wherein the l-th bit field comprises MQ·RI bits. In certain embodiments, the 2L or 2L′ groups or bit fields are ordered with respect to an increasing SD component index. In certain embodiments, the 2L or 2L′ groups are ordered with respect to a permutation function of L or 2L SD component indices.

### Ordering Schemes for Option 11 and Option 12:

In certain embodiments, the ordering of the bits within each l-th bit field is a function of the FD component index (m), TD component index (q) and layer index (r), and is given by u=MQr+Qm+q, where r={0, . . . , RI}, q={0, . . . , Q−1}, and m={0, . . . , M−1}.

In certain embodiments, the ordering of the bits within each l-th bit field is a function of the FD component index (m), TD component index (q) and layer index (r), and is given by u=MQr+Mq+m, where r={0, . . . , RI}, q={0, . . . , Q−1}, and m={0, . . . , M−1}.

In certain embodiments, the ordering of the bits within each l-th bit field is a function of the FD component index (m), TD component index (q) and layer index (r), and is given by u=M RI·q+Rm+r, where r={0, . . . , RI}, q={0, . . . , Q−1}, and m={0, . . . , M−1}.

In certain embodiments, the ordering of the bits within each l-th bit field is a function of the FD component index (m), TD component index (q) and layer index (r), and is given by u=M RI·q+Mr+m, where r={0, . . . , RI}, q={0, . . . , Q−1}, and m={0, . . . , M−1}.

In certain embodiments, the ordering of the bits within each l-th bit field is a function of the FD component index (m), TD component index (q) and layer index (r), and is given by u=Q·RI·m+Qr+q, where r={0, . . . , RI}, q={0, . . . , Q−1}, and m={0, . . . , M−1}.

In certain embodiments, the ordering of the bits within each l-th bit field is a function of the FD component index (m), TD component index (q) and layer index (r), and is given by u=Q·RI·m+RI·q+r, where r={0, . . . , RI}, q={0, . . . , Q−1}, and m={0, . . . , M−1}.

In certain embodiments, the ordering of S bit fields is based on any permutation function of the S SD-FD component pairs, where S≤2LM. In certain embodiments, the ordering of S bit fields is based on any permutation function of the S SD-TD component pairs, where S≤2LQ. In certain embodiments, the ordering of S bit fields can be based on any permutation function of the S FD-TD component pairs, where S≤MQ.

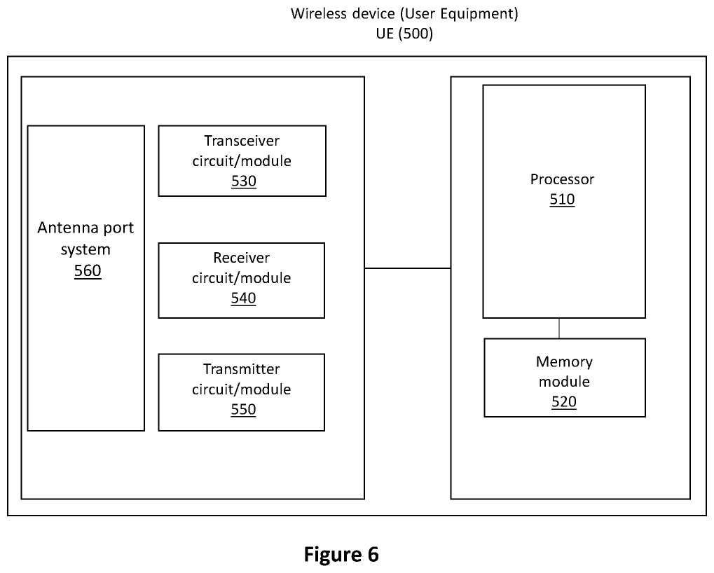

In order to perform the previously described process or method steps performed by the wireless or UE there is also provided a wireless device. FIG. 6 illustrates a block diagram depicting a wireless device or UE 500. The wireless device 500 comprises a processor 510 or processing circuit or a processing module or a processor means 510; a receiver circuit or receiver module 540; a transmitter circuit or transmitter module 550; a memory module 520, a transceiver circuit or transceiver module 530 which may include the transmitter circuit 550 and the receiver circuit 540. The wireless device 500 further comprises an antenna system 560 which includes antenna circuitry for transmitting and receiving signals to/from at least the network node or other wireless device(s). The antenna system employs beamforming as previously described.

The wireless device 500 may belong to any radio access technology including 4G or LTE, LTE-A, 5G, advanced 5G or a combination thereof that support beamforming technology. The wireless device comprising the processor and the memory contains instructions executable by the processor, whereby the wireless device 500 is operative or is configured to perform any one of the embodiments related to the wireless device as previously described.

The processing module/circuit 510 includes a processor, microprocessor, an application specific integrated circuit (ASIC), field programmable gate array (FPGA), or the like, and may be referred to as the “processor.” The processor 510 controls the operation of the wireless device and its components. Memory (circuit or module) 520 includes a random-access memory (RAM), a read only memory (ROM), and/or another type of memory to store data and instructions that may be used by processor 510. In general, it will be understood that the wireless device 500 in one or more embodiments includes fixed or programmed circuitry that is configured to carry out the operations in any of the embodiments disclosed herein.

In at least one such example, the processor 510 includes a microprocessor, microcontroller, DSP, ASIC, FPGA, or other processing circuitry that is configured to execute computer program instructions from a computer program stored in a non-transitory computer-readable medium that is in or is accessible to the processing circuitry. Here, “non-transitory” does not necessarily mean permanent or unchanging storage, and may include storage in working or volatile memory, but the term does connote storage of at least some persistence. The execution of the program instructions specially adapts or configures the processing circuitry to carry out the operations disclosed in this disclosure relating to the wireless device. Further, it will be appreciated that the wireless device 500 may comprise additional components.

The wireless device 500 by means of processor 510 executes instructions contained in the memory 520 whereby the wireless device is operative to perform any one of the previously described embodiments related to the actions performed by the wireless device, some of which are presented in appended claims.

There is also provided a computer program comprising instructions which when executed by the processor 510 of the wireless device cause the processor 510 to carry out the method according to any one of the previously described embodiments.

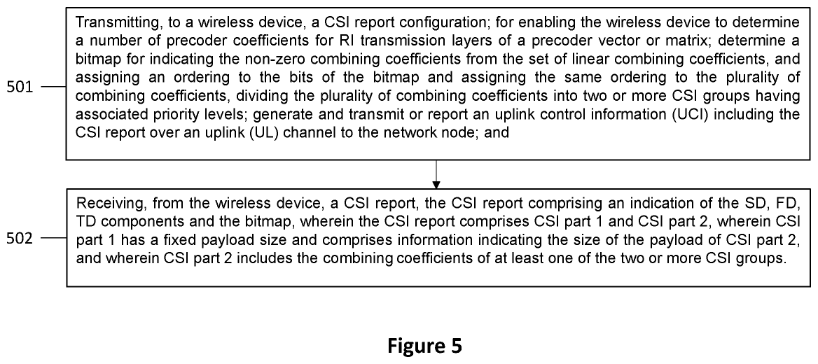

There is also provided a method performed by a network node for receiving a CSI report in a wireless communication system, the CSI report indicating a plurality of precoder vectors or matrices, a precoder vector or matrix being expressed as a linear combination of spatial-domain component(s), frequency-domain component(s) and time-domain component(s), and a set of linear combination coefficients for combining the spatial-, frequency- and time-domain components. FIG. 5 illustrates the main method steps, which comprise:
transmitting (501) to a wireless device (500), a CSI report configuration; for enabling the wireless device (500) to determine a number of precoder coefficients for RI transmission layers of a precoder vector or matrix; determine a bitmap for indicating the non-zero combining coefficients from the set of linear combining coefficients, and assigning an ordering to the bits of the bitmap and assigning the same ordering to the plurality of combining coefficients, dividing the plurality of combining coefficients into two or more CSI groups having associated priority levels; generate and transmit or report an uplink control information (UCI) including the CSI report over an uplink (UL) channel to the network node (600); and
receiving (502), from the wireless device (500), a CSI report, the CSI report comprising an indication of the SD, FD, TD components and the bitmap, wherein the CSI report comprises CSI part 1 and CSI part 2, wherein CSI part 1 has a fixed payload size and comprises information indicating the size of the payload of CSI part 2, and wherein CSI part 2 includes the combining coefficients of at least one of the two or more CSI groups, and wherein the content of the CSI report is determined by the wireless device (500) according to Claim 1. The actions performed by the wireless device for determining the CSI report for transmission to the network node were previously presented and need not be repeated.

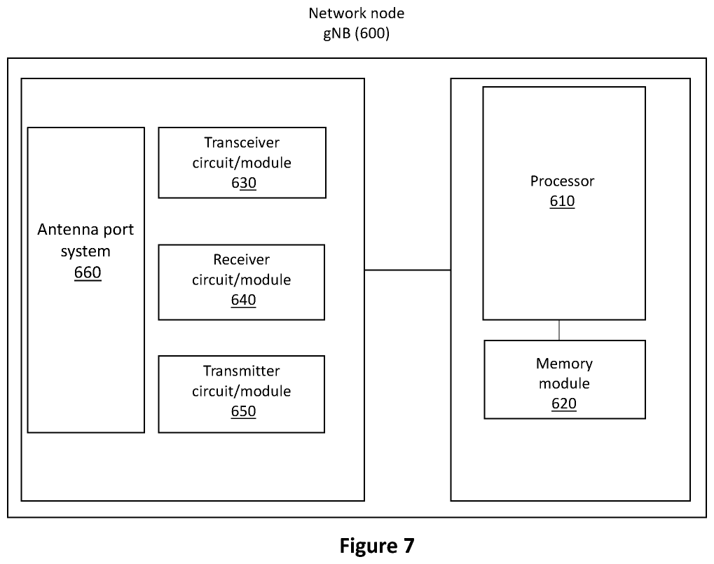

In order to perform the previously described process or method steps performed by the network node there is also provided a network node. FIG. 7 illustrates a block diagram depicting a network node 600. The network node 600 comprises a processor 610 or processing circuit or a processing module or a processor means 610; a receiver circuit or receiver module 640; a transmitter circuit or transmitter module 650; a memory module 620, a transceiver circuit or transceiver module 630 which may include the transmitter circuit 650 and the receiver circuit 640. The network node 600 further comprises an antenna system 660 which includes antenna circuitry for transmitting and receiving signals to/from at least the wireless device. The antenna system employs beamforming as previously described.

The network node 600 may belong to any radio access technology including 4G or LTE, LTE-A, 5G, advanced 5G or a combination thereof that support beamforming technology. The network device comprising the processor and the memory contains instructions executable by the processor, whereby the network node 600 is operative or is configured to perform any one of the embodiments related to the network node 600 as previously described.

The processing module/circuit 610 includes a processor, microprocessor, an application specific integrated circuit (ASIC), field programmable gate array (FPGA), or the like, and may be referred to as the “processor.” The processor 610 controls the operation of the network node and its components. Memory (circuit or module) 620 includes a random-access memory (RAM), a read only memory (ROM), and/or another type of memory to store data and instructions that may be used by processor 610. In general, it will be understood that the network node in one or more embodiments includes fixed or programmed circuitry that is configured to carry out the operations in any of the embodiments disclosed herein.

In at least one such example, the processor 610 includes a microprocessor, microcontroller, DSP, ASIC, FPGA, or other processing circuitry that is configured to execute computer program instructions from a computer program stored in a non-transitory computer-readable medium that is in or is accessible to the processing circuitry. Here, “non-transitory” does not necessarily mean permanent or unchanging storage, and may include storage in working or volatile memory, but the term does connote storage of at least some persistence. The execution of the program instructions specially adapts or configures the processing circuitry to carry out the operations disclosed in this disclosure relating to the wireless device. Further, it will be appreciated that the wireless device 600 may comprise additional components. The network node 600 may also be viewed as a Transmitter and Receiver Point (TRP).

The network node 600 by means of processor 610 executes instructions contained in the memory 620 whereby the network node 600 is operative to perform any one of the previously described embodiments related to the actions performed by the network node, some of which are presented in appended claim 8.

There is also provided a computer program comprising instructions which when executed by the processor 610 of the network node cause the processor 610 to carry out the method according to any one of claim 8.

Several advantages of the described embodiments in this disclosure are achieved as previously described and which include significantly reducing the feedback overhead and the computational complexity at the wireless device for codebook-based CSI reporting. Another advantage is to reduce latency in the CSI reporting.

Reference throughout this specification to “an example” or “exemplary” means that a particular feature, structure, or characteristic described in connection with the example is included in at least one embodiment of the present technology. Thus, appearances of the phrases “in an example” or the word “exemplary” in various places throughout this specification are not necessarily all referring to the same embodiment.

Throughout this disclosure, the word “comprise” or “comprising” has been used in a non-limiting sense, i.e. meaning “consist at least of”. Although specific terms may be employed herein, they are used in a generic and descriptive sense only and not for purposes of limitation. The embodiments herein may be applied in any wireless systems including LTE or 4G, LTE-A (or LTE-Advanced), 5G, advanced 5G, WiMAX, WiFi, satellite communications, TV broadcasting etc.

1. A method performed by a wireless device for generating and reporting or transmitting a channel state information (CSI) report in a wireless communication system, the CSI report indicating a plurality of precoder vectors or matrices, a precoder vector or matrix being expressed as a combination of spatial-domain (SD) component(s), frequency-domain (FD) component(s), and time-domain (TD) component(s), and a set of combining coefficients for combining the spatial-, frequency- and time-domain components, the method comprising:
receiving a CSI report configuration from a network node;
determining based on the received CSI report configuration a number of precoder coefficients for rank index (RI) transmission layers of a precoder vector or matrix;
determining a bitmap for indicating non-zero combining coefficients from the set of combining coefficients, and assigning an ordering to bits of the bitmap and assigning the same ordering to the set of combining coefficients;
dividing the set of combining coefficients into two or more CSI groups having associated priority levels;
generating a CSI report comprising an indication of the SD, FD, TD components and the bitmap, wherein the CSI report comprises CSI part 1 and CSI part 2, wherein CSI part 1 has a fixed payload size and comprises information indicating the size of the payload of CSI part 2, and wherein CSI part 2 includes the combining coefficients of at least one of the two or more CSI groups, wherein differential amplitude values of K or less than K non-zero combining coefficients in the CSI report are quantized with B bits of differential amplitude values, and wherein the total number of bits associated with the differential amplitude values of the K or less than K non-zero combining coefficients is segmented into two segments, wherein a first segment comprises a maximum of max
$$( 0 , ( ⌈ \frac{K}{2} ⌉ - RI ) ) \cdot B bits$$
and is assigned to CSI group 1, and a second segment comprises a maximum of min
$$( K - RI , ⌊ \frac{K}{2} ⌋ ) \cdot B bits$$
and is assigned to CSI group 2; and
transmitting or reporting an uplink control information (UCI) including the CSI report over an uplink (UL) channel to the network node.

2. The method according to claim 1, wherein one or more SD components, one or more FD components, one or more TD components for the set of combination coefficients are determined by the wireless device for the precoding vector or matrix, and wherein the one or more SD, FD, and TD components are indicated in the CSI report.

3. The method according to claim 1, wherein a number, S, FD-TD, or SD-TD, or SD-FD component pairs are derived from the parameter M and Q, wherein M is the number of configured FD components, and Q is the number of configured TD components of the precoding matrix.

4. The method according to claim 1, wherein the CSI report comprises multiple CSI groups for UCI or CSI omission, and the bitmap comprises S bit fields, wherein an s-th bit field, with s={0, . . . , S−1}, is associated with an s-th FD-TD component pair index and comprises 2L·RI bits, with L representing the number of SD components, wherein an FD-TD component pair is a pair comprising an FD component and an TD component, and the ordering of the bits in the s-th bit field corresponds to the ordering of the combining coefficients associated with the bits of the s-th bit field.

5. The method according to claim 4, wherein each bit with a bit index u within the s-th bit field is associated with an SD component index l and a layer index r by u=RI·I+r, wherein u={0, . . . , 2L, RI−1}, l={0, . . . , 2L−1}, and r={0, . . . , RI−1}.

6. The method according to claim 4, wherein a mapping between an FD component m and a TD component q to an s-th FD-TD component pair is given by s=Mq+m, where q∈{0, . . . , Q−1} is a TD component index and M∈{0, . . . , M−−1} is an FD component index, with M representing the number of configured FD components, and Q representing the number of configured TD components.

7. The method according to claim 4, wherein the ordering of the S bit fields can be based on any permutation function of the S FD-TD component pairs, wherein S≤MQ, with M representing the number of configured FD components, and Q representing the number of configured TD components.

8. The method according to claim 4, wherein the S FD-TD component pairs associated with the S bit fields are grouped into Q groups, wherein a q-th group comprises M FD-TD component pairs associated with the same TD component and M represents the number of configured FD components, and wherein the Q groups are ordered with respect to an increasing TD component index and Q represents the number of configured TD components.

9. The method according to claim 8, wherein each bit with a bit index u of the q-th group is associated with an SD component index 1, a layer index r, and an FD component index m by u=2L·RI·m+RI·l+r, where u={0, . . . , 2LM·RI·l}, r={0, . . . , RI−1}, m={0, . . . , M−1}, and l={0, . . . , 2L−1}.

10. The method according to claim 1, wherein the bits of the bitmap are segmented into two segments, wherein the first segment comprises the first
$$2 LS \cdot RI - ⌊ \frac{K}{2} ⌋ bits$$
and assigned to CSI group 1 and the second segment comprises the remaining
$$⌊ \frac{K}{2} ⌋ bits$$
and assigned to CSI group 2, and wherein S≤MQ, M representing the number of configured FD components, and Q representing the number of configured TD components.

11. The method according to claim 1, wherein phase values of K or less than K non-zero combining coefficients in the CSI report are quantized with C bits, and wherein the total number of bits associated with the phase values of the K or less than K non-zero combining coefficients is segmented into two segments, wherein a first segment comprises a maximum of max
$$( 0 , ( ⌈ \frac{K}{2} ⌉ - RI ) ) \cdot C bits$$
and is assigned to CSI group 1, and a second segment comprises a maximum of min
$$( K - RI , ⌊ \frac{K}{2} ⌋ ) \cdot C bits$$
and is assigned to CSI group 2.

12. A method performed by a network node for receiving a channel state information (CSI) report in a wireless communication system, the CSI report indicating a plurality of precoder vectors or matrices, a precoder vector or matrix being expressed as a combination of spatial-domain (SD) component(s), frequency-domain (FD) component(s) and time-domain (TD) component(s), and a set of combining coefficients for combining the spatial, frequency- and time-domain components, the method comprising:
transmitting to a wireless device, a CSI report configuration, for enabling the wireless device to determine based on the CSI report configuration a number of precoder coefficients for rank index (RI) transmission layers of a precoder vector or matrix, to determine a bitmap for indicating non-zero combining coefficients from the set of combining coefficients, to assign an ordering to bits of the bitmap and to assign the same ordering to the set of combining coefficients, to divide the set of combining coefficients into two or more CSI groups having associated priority levels, and to generate and transmit or report an uplink control information (UCI) including the CSI report over an uplink (UL) channel to the network node; and
receiving, from the wireless device, the CSI report, the CSI report comprising an indication of the SD, FD, TD components and the bitmap, wherein the CSI report comprises CSI part 1 and CSI part 2, wherein CSI part 1 has a fixed payload size and comprises information indicating the size of the payload of CSI part 2, and wherein CSI part 2 includes the combining coefficients of at least one of the two or more CSI groups, wherein differential amplitude values of K or less than K non-zero combining coefficients in the CSI report are quantized with B bits of differential amplitude values, and wherein the total number of bits associated with the differential amplitude values of the K or less than K non-zero combining coefficients is segmented into two segments, wherein a first segment comprises a maximum of max
$$( 0 , ( ⌈ \frac{K}{2} ⌉ - RI ) ) \cdot B bits$$
and is assigned to CSI group 1, and a second segment comprises a maximum of min
$$( K - RI , ⌊ \frac{K}{2} ⌋ ) \cdot B bits$$
and is assigned to CSI group 2.

13. A network node comprising a processor and a memory containing instructions executable by said processor, for receiving a channel state information (CSI) report in a wireless communication system, the CSI report indicating a plurality of precoder vectors or matrices, a precoder vector or matrix being expressed as a combination of spatial-domain (SD) component(s), frequency-domain (FD) component(s) and time-domain (TD) component(s), and a set of combining coefficients for combining the spatial-, frequency- and time-domain components, whereby the network node is configured to:
transmit to a wireless device, a CSI report configuration; for enabling the wireless device to determine based on the CSI report configuration a number of precoder coefficients for rank index (RI) transmission layers of a precoder vector or matrix, to determine a bitmap for indicating non-zero combining coefficients from the set of combining coefficients, to assign an ordering to bits of the bitmap and to assign the same ordering to the set of combining coefficients, to divide the set of combining coefficients into two or more CSI groups having associated priority levels, and to generate and transmit or report an uplink control information (UCI) including the CSI report over an uplink (UL) channel to the network node; and
receive, from the wireless device, the CSI report, the CSI report comprising an indication of the SD, FD, TD components and the bitmap, wherein the CSI report comprises CSI part 1 and CSI part 2, wherein CSI part 1 has a fixed payload size and comprises information indicating the size of the payload of CSI part 2, and wherein CSI part 2 includes the combining coefficients of at least one of the two or more CSI groups, wherein differential amplitude values of K or less than K non-zero combining coefficients in the CSI report are quantized with B bits of differential amplitude values, and wherein the total number of bits associated with the differential amplitude values of the K or less than K non-zero combining coefficients is segmented into two segments, wherein a first segment comprises a maximum of max
$$( 0 , ( ⌈ \frac{K}{2} ⌉ - RI ) ) \cdot B bits$$
and is assigned to CSI group 1, and a second segment comprises a maximum of min
$$( K - RI , ⌊ \frac{K}{2} ⌋ ) \cdot B bits$$
and is assigned to CSI group 2.

14. A wireless device comprising a processor and a memory containing instructions executable by said processor, for generating and reporting or transmitting a channel state information (CSI) report in a wireless communication system, the CSI report indicating a plurality of precoder vectors or matrices, a precoder vector or matrix being expressed as a combination of spatial-domain (SD) component(s), frequency-domain (FD) component(s), and time-domain (TD) component(s), and a set of combining coefficients for combining the spatial-, frequency- and time-domain components, whereby the wireless device is configured to:
receive a CSI report configuration from a network node;
determine based on the received CSI report configuration a number of precoder coefficients for rank index (RI) transmission layers of a precoder vector or matrix;
determine a bitmap for indicating non-zero combining coefficients from the set of combining coefficients, and assigning an ordering to bits of the bitmap and assigning the same ordering to the set of combining coefficients;
divide the set of combining coefficients into two or more CSI groups having associated priority levels;
generate a CSI report comprising an indication of the SD, FD, TD components and the bitmap, wherein the CSI report comprises CSI part 1 and CSI part 2, wherein CSI part 1 has a fixed payload size and comprises information indicating the size of the payload of CSI part 2, and wherein CSI part 2 includes the combining coefficients of at least one of the two or more CSI groups, wherein differential amplitude values of K or less than K non-zero combining coefficients in the CSI report are quantized with B bits of differential amplitude values, and wherein the total number of bits associated with the differential amplitude values of the K or less than K non-zero combining coefficients is segmented into two segments, wherein a first segment comprises a maximum of max
$$( 0 , ( ⌈ \frac{K}{2} ⌉ - RI ) ) \cdot B bits$$
and is assigned to CSI group 1, and a second segment comprises a maximum of min
$$( K - RI , ⌊ \frac{K}{2} ⌋ ) \cdot B bits$$
and is assigned to CSI group 2; and
transmit or report an uplink control information (UCI) including the CSI report over an uplink (UL) channel to the network node.
